(19) United States
(12) Patent Application Publication
(10) Pub. No.: US 2009/0208143 A1
(43) Pub. Date: Aug. 20, 2009

(54) EFFICIENT AUTOMATED UROTHELIAL IMAGING USING AN ENDOSCOPE WITH TIP BENDING

(75) Inventors: Woon Jong Yoon, Seattle, WA (US); Eric Seibel, Seattle, WA (US); Robert Sweet, Edina, MN (US); Per Reinhall, Seattle, WA (US)

Correspondence Address: LAW OFFICES OF RONALD M ANDERSON, 600 108TH AVE, NE, SUITE 507, BELLEVUE, WA, 98004, US

(73) Assignee: University of Washington, Seattle, WA (US)

(21) Appl. No.: 12/033,826

(22) Filed: Feb. 19, 2008

(51) Int. Cl. G06K 9/20

(52) U.S. Cl. 382/321; 382/312

(57) ABSTRACT

A scanning fiber endoscope (SFE) disposed at the distal end of a flexible, small diameter imaging probe is inserted through a relatively small opening and into a larger volume, such as the bladder. Actuators disposed adjacent to the distal end of the imaging probe are selectively activated to bend the distal end of the imaging probe to assist in positioning and orienting the SFE at a plurality of points selected to image substantially all of at least a desired portion of the interior surface of the volume. The insertion depth, bending arc, and rotational position of the imaging probe can be manually and/or automatically controlled. The user can inspect the images to determine if a desired portion of the surface has been imaged and can thus ensure that a tumor or other characteristic of the surface is not overlooked due to a failure to image it.

### GOVERNMENT RIGHTS

This invention was made with government support under Contract or Grant No. R33 CA094303 awarded by National Cancer Institute—National Institutes of Health (NCI—NIH). The government has certain rights in the invention.

### BACKGROUND

Urothelial cancers involve the bladder, ureters and renal collecting system. Bladder cancer was ranked as the fourth most prevalent cancer for males and the ninth most prevalent cancer for females in 2005. Furthermore, bladder cancer has also been reported as the most expensive cancer from diagnosis to death due to its high surveillance and monitoring costs and inpatient hospital costs since it needs lifelong routine monitoring and treatment. Out of the estimated 63,210 new bladder cases in the U.S. population during 2005, 89% occurred among men and women who were older than 55 years old.

It is well understood that early detection reduces the mortality of urothelial cancer, since bladder cancer is rarely first discovered at the time of autopsy. Thus, most bladder tumors will develop into symptomatic medical issues, such as blood in the urine or irritative urinary voiding symptoms, and many are found as “clinically significant.” Bladder tumors also have a significant risk for multiple tumor recurrences with respect to time and space, e.g., additional bladder tumors tend to recur in 60% of all bladder cancer cases. Therefore, bladder cancer is an ideal disease for screening in a high-risk population including heavy cigarette smokers and workers who are exposed to hazardous chemicals and environmental toxins. It has been noted that screening to identify a bladder tumor for high-risk patients who have an annual 4% incidence of bladder cancer can produce about a three life-year increase per 1,000 subjects at a cost savings of $101,000 for the population. In addition, patients treated for bladder cancer need careful follow-up and regular monitoring of superficial bladder tumors after treatment to avoid the high risk of recurrence and progression to a higher stage of the disease. Thus, urologists recommend that patients with tumors of any stage should typically have inspections of the bladder with a scope (cystoscopy) and bladder wash urine cytology every three months for the first year following discovery of the disease and an annual upper tract study involving intravenous contrast and an X-ray or Computed Tomography (CT) scan. If there are no signs of disease after the first year of surveillance, follow-up monitoring should continue every six months during the second year, and yearly cystoscopic examinations should follow after two years of intensive monitoring.

Conventionally bladder tumors/malignancies are detected via urine cytology, and/or via upper urinary tract studies such as CT urograms, intravenous pyelographies (IVP), ultrasound or Magnetic Resonance Imaging (MRI). The gold standard examination of the lower urinary tract consists of an optical examination of the bladder or cystoscopy. A brief summary of the diagnostic tools follows.

### Urine Cytology

The urine-based tumor markers are non-invasive and cost-effective for diagnosis of bladder tumors, especially for a high-risk population. However, the sensitivity of tumor markers is as low as 55.7% compared to the much higher results for Computed Tomography/Magnetic Resonance Imagery (CT/MRI) cystoscopy (88.9-100%), and conventional CT images (76-80%). Missed recurrences or false-negatives due to the low sensitivity of the urinary markers seemed to be problematic.

### IVP

IVP is a minimally invasive diagnostic procedure and uses contrast material with X-ray imaging to thoroughly examine the upper urinary tract for the presence of any malignancies. Contrast material is injected into the patient's arm, travels through blood vessels, and is excreted by the kidneys into the urinary tract of the patient, effectively “lighting up” the outline of the collecting system and ureters. Administration of an IV contrast is a relatively safe procedure, with only rare complications, such as contrast allergy and acute renal failure, although the patient receives some radiation from the X-ray and even more radiation during a CT urogram, which is sometimes the upper-tract study of choice during a work-up for blood in the urine (a common presenting complaint for patients with bladder cancer) because of its enhanced ability to detect kidney cancers. These procedures are costly and thus, using ultrasound as the initial tests results in the lowest cost per case diagnosed at all prevalence levels, compared with IVP, but is less sensitive for identifying upper tract urothelial disease.

### Cystoscopy

Of all tumor recurrences, 60-75% are recognized only by cystoscopy. Long-term endoscopic follow-up in the upper urinary tract and bladder after the treatment is indispensable to ensure early detection and treatment of recurrences. For males, cystoscopy involves passing a scope through the orifice at the tip of the penis retrograde into the bladder. It is typically done under local anesthetic in the clinic as an outpatient procedure. As a routine surveillance exam, conventional cystoscopy exhibits some problems. First, it is painful; current cystoscopes range from 10F to 28F, flexible ureteroscopes are about 7F, and flexible cystoscopes and rigid cystoscopes, which are inserted through the urethra, are about 14F. (The term “French” (F) is commonly used as an indication of the diameter of medical devices such as catheters and can be divided by the mathematical constant π (or roughly 3) to determine the corresponding diameter in mm.) According to some experts in this field, a thinner scope would be significantly beneficial in reducing a patients' discomfort and would therefore be preferred if it provides little loss of image quality compared to rigid cystoscopes, is reasonably priced, and has better usability. It has been proposed that a flexible small-caliber instrument should be used for most diagnostic cystoscopies, and larger cystoscopes should be reserved for operative intervention. In a standard rigid cystoscopic exam, the clinician may miss one or more multiple tumors near the bladder neck, due to the limited flexibility of the scope. In addition, the sensitivity of the manually-operated endoscopic monitoring depends on the experience of the clinician, since it only allows an operator to see a small portion of the bladder at a time.

Flexible ureteroscopes (FUs), in conjunction with baskets and lasers, have been developed for use in examining the upper urinary tract, accessing the kidney, and treating renal calculi, as well as some small urothelial tumors and strictures (scar tissue). Procedures for using FUs (which are about 2.4 mm in diameter) still require ureteral dilation and guidewires in around 11% and 52% of all cases, respectively. A FU is steered by using internal wires for bending a multi-linked metal structure at the tip, and the bend radius is typically >20 mm. The current approach is considered too costly for the smaller diameter FU (with diameters <2 mm). Furthermore, the wires for tip bending require a relatively rigid casing for support, limiting overall flexibility of the scope. The most recent design changes in FU, such as decreased diameter and secondary deflection system, are accompanied by greater fragility and higher repair costs (average lifespan is only ten patient cases between repairs).

### Other Procedures

CT, MRI, and ultrasound for grading the tumor are used for patients with suspected bladder carcinoma and for hematuria work ups. Although CT has a sensitivity of around 90%, it does not readily distinguish low volume tumors. Due to the limitations of axial CT and MRI images that produce non-contiguous bladder images, new technologies such as spiral CT and MRI cystoscopes that provide virtual cystoscopy have been introduced. They have several advantages, including imaging of the bladder in multiple planes and a 360 degree view requiring no anesthesia. They provide minimal discomfort and risk for the patient which is not available at conventional cystoscopy. However, radiation exposure for these examinations is significant. Radiation exposure in high doses as with screening examinations has been linked with the development of other malignancies. Significantly, 10% of bladder lesions, which were smaller than 5 mm, were detected by the direct visualization, cystoscopy, but were not detected by CT images and virtual cystoscopy. Accordingly, CT virtual cystoscopy is a promising technique only when the tumors are larger than 5 mm. Virtual endoscopy exams may be also potentially criticized because they provide insufficient information regarding the color and texture of the mucosa and do not permit taking biopsies. Flat erythematous (red) lesions can pose a diagnostic dilemma, and the discovery of such lesions may lead to biopsy based on the clinician's index of suspicion; yet, they can represent cancer or may be benign.

New fluorescent probes have been developed for early detection of cancer. However, it is apparent that CT imaging cannot benefit from the new fluorescent probes.

Based on the preceding discussion, it will be apparent that there is a clear justification for developing cost-effective postoperative follow-up exams and preventive screening tools for a high-risk population. Given the advantages of cystoscopic exams compared to other procedures available for detecting bladder cancers and other urinary tract conditions, it would be desirable to develop cost-effective FUs having smaller diameters that can be readily controlled to scan any desired region in a patient's bladder, ureters, and renal pelvis and which can be inserted with minimal discomfort. The ability to automatically provide a map of the scanned organ indicating tumor location and size would also be advantageous for record keeping, continuity of care, and pre-operative planning. Another advantage over cystoscopy would be the ability to image “deeper” than the visible surface for treatment planning and prognostic purposes. Such devices would have many other applications in the medical field and can also be employed for non-medical tasks, where it is necessary to insert an imaging probe through a relatively smaller diameter entrance opening and into a relatively larger volume, to scan a surface or subsurface in the volume.

### SUMMARY

From the foregoing discussion, it will be evident that there is motivation to develop a relatively small diameter (e.g., 2 mm or less) flexible imaging scope with active steering at its distal tip, to reduce stress on the scope shaft by eliminating the internal angulation wires, while also minimizing tissue trauma when the scope is inserted. Accordingly, a multi-segmented shape memory alloy (SMA) actuator was created that can produce smooth graded motion at the distal tip of an imaging device. This actuator has been fitted to an ultrathin scanning fiber imaging device. The resulting scanning fiber imaging device (or more broadly, “imaging probe”) employing this actuator to provide a steerable distal tip thus comprises a guidewire with “eyes” (i.e., with imaging capability), and is expected to reduce the procedural time and complications of current techniques, eliminate X-ray guidance, and provide more space for adjunctive instrumentation, along with having better performance and possibly lower cost than conventional flexible endoscopes.

A procedure is described below to use this type of imaging device with a bendable distal tip for scanning a surface or subsurface within a volume. Of particular importance is the ability of the procedure to ensure that all of the surface or subsurface within a volume is imaged.

Accordingly, one aspect of this technology is directed to a method for scanning and mapping substantially all of a surface within an internal volume that is accessed through an opening relatively smaller in a cross-sectional dimension than a cross-sectional dimension of the volume. The method can thereby produce images of the surface in which a condition of the surface is visually evident by the imaging modality, and can ensure that at least a desired portion of the surface or subsurface has been imaged. As used in the following description and in the claims that follow, the term “surface” is intended to encompass not only the inner-most level of the material forming the wall of a volume, but also is intended to include sub-surface levels of the wall, which may be evident in images made with techniques such as confocal imaging of the wall.

One exemplary method includes the step of inserting an imaging probe into the volume through the opening. The imaging probe is then successively remotely positioned at each of a plurality of positions selected to enable imaging of different parts of the surface. A distal end of the imaging probe is remotely bent through an arc, to assist in the step of remotely positioning, by applying a mechanical force to the imaging probe proximate to the distal end. Bending the imaging probe thus changes a position and an orientation of the distal end of the imaging probe relative to a portion of the surface that is currently being imaged. At each of the positions, the imaging probe is used for imaging the surface to produce a plurality of images of the surface. An indication is provided to a user of the imaging device that enables the user to determine whether images have been produced for substantially all of at least the desired portion of the surface.

The step of successively remotely positioning can include the step of successively remotely changing a depth of insertion of the imaging probe into the volume. Similarly, the step of successively remotely positioning can include the step of successively remotely rotating the imaging probe about a longitudinal axis of the imaging probe.

The method can also include the step of injecting a fluid under pressure into the volume to distend the surface before and during the step of imaging the surface.

Another step of the method involves displaying the images that are produced to the user to enable the user to visually determine whether substantially all of at least the desired portion of the surface has been imaged by the imaging probe. To assist the user in this determination, the method can also include the step of combining the images of the surface to create an overall composite image in which any part of the surface that has not been imaged is visually evident. In this case, the step of providing an indication to the user comprises the step of displaying the overall composite image to the user to enable the user to visually determine if substantially all of at least the desired portion of the surface has been imaged. Based on the results of this determination, the imaging probe can be further positioned and oriented to image any part of at least the desired portion of the surface that has been identified by the user as having not yet been imaged.

The step of remotely positioning the imaging probe can be carried out automatically using a controller that controls a position of the imaging probe within the volume while the imaging probe is being used for imaging. The controller can be used to activate one or more actuators that are disposed on the imaging probe, adjacent to its distal end to remotely bend the distal end of the imaging probe. Typically, the controller will select one or more specific actuators to be activated, so as to bend the distal end of the imaging probe through an arc that will position and orient the distal end at successive positions chosen to ensure that at least the desired portion of the surface is imaged. Alternatively (or in addition to automatically controlling at least some portion of the positioning and orienting the imaging probe), a user can selectively activate one or more actuators that are disposed on the imaging probe, adjacent to its distal end, so as to bend the distal end of the imaging probe through an arc that will position and orient the distal end at successive positions chosen to ensure that at least the desired portion of the surface is imaged. The user can also manually manipulate a proximal portion of the imaging probe to enable imaging of the surface at each of the plurality of positions. Finally, the controller can automate this manual procedure robotically controlling the proximal portion of the imaging probe.

If the surface visually exhibits at least one characteristic condition, the method can also include the step of displaying the plurality of images of the surface so as to enable the user to determine whether the at least one characteristic condition is visible in any of the plurality of images.

Optionally, the method can include the step of sensing a position of the imaging probe in the volume, producing a signal indicative of at least one of the position and orientation of the imaging probe. If this option is employed, the step of providing the indication to the user can comprise the step of providing the indication produced in response to the signal to the user, to enable the user to modify at least one of the position and orientation of the imaging probe so as to ensure that substantially all of at least the desired portion of the surface is imaged.

In this method, a plurality of actuators can be disposed on the imaging probe, adjacent to the distal end of the imaging probe. The step of remotely bending can then comprise the step of applying an electrical signal for activating one or more selected actuators. Activation of the one or more selected actuators causes the selected actuator(s) to change shape, producing a force that bends the imaging probe through an arc.

Another aspect of this novel development is directed to a system for scanning a surface of a volume that is accessed through an opening, where a cross-sectional dimension of the volume is substantially greater than a cross-sectional dimension of the opening. The system includes an elongate imaging probe that is used for creating images of a surface that is being scanned. The cross-sectional dimension of the elongate imaging probe is sufficiently small to enable the elongate imaging probe to readily fit through the opening when inserted into the volume. Further, the elongate imaging probe is flexible at least adjacent to a distal end of the elongate imaging probe. At least one actuator is disposed on the elongate imaging probe and is used for producing a mechanical force that bends the elongate imaging probe. A plurality of electrical conductors are coupled to the at least one actuator and convey an electrical signal used to selectively activate one or more actuators, so that they bend the elongate optical scanning device through a desired arc. In this manner, the elongate imaging probe is bent in the desired arc and positioned within the volume when producing images of the surface at each of a plurality of positions. These positions are selected to ensure that substantially all of at least a desired portion of the surface of the volume is scanned.

The system further includes a flexible sheath that encloses the elongate imaging probe and has an optically transparent window at its distal end. Light is readily transmitted through the transparent window when the elongate imaging probe is imaging the surface.

Some exemplary embodiments of the system include at least one light detector that receives light from the surface, producing an output signal in response to the light received. This output signal is used in producing images of the surface or subsurface. The one or more light detectors are disposed adjacent to the distal end of the elongate imaging probe. The output signal from each is conveyed by a plurality of leads that extend from the light detector(s) toward the proximal end of the elongate imaging probe.

In other exemplary embodiments, at least one optical fiber extends along the elongate imaging probe, from its distal end, toward its proximal end. The one or more optical fibers convey light received from the surface to one or more light detectors.

An image processor can be included for processing the output signal. In addition, the image processor can process a plurality of overlapping discrete images of different portions of the surface so as to produce an overall image in which the plurality of discrete images are combined. The system can further include a display on which the overall image is displayed to a user, to enable the user to determine if at least the desired portion of the surface has been fully scanned. The user makes this determination by inspecting the overall image on the display to determine if any part of the desired portion of the surface is not visually evident in the overall image.

In addition, the image processor can control imaging by the elongate imaging probe to produce the plurality of overlapping discrete images so as to ensure that substantially all of the desired portion of the surface is optically scanned and with sufficient image quality. It provides this capability by automatically controlling one or more of the insertion depth of the elongate imaging probe, its rotation, its longitudinal axis, and the bending of the elongate imaging probe about an arc.

Optionally, a position sensing system can be included to detect the position and orientation of the distal end of the elongate imaging probe within the volume. This information can be employed to enable the processor to control the position and orientation of the elongate optical sensor so as to ensure that substantially all of the desired portion of the surface has been imaged.

Another component of the exemplary system is a source of a fluid that is injected into the volume through the opening under pressure. This fluid distends the surface, prior to the system optically scanning the surface with the elongate imaging probe. The distension of the surface may be modified by varying the applied fluid pressure or flow rate of the fluid during the imaging procedure to ensure that at least the desired portion of the volume is able to be fully scanned and with a sufficient image quality.

In some embodiments, each actuator comprises a shape memory alloy or polymer. The plurality of electrical conductors then carries an electrical current to heat each actuator that is to be activated. The heating of an actuator causes the actuator to change shape, producing the force that bends the elongate imaging probe. Alternatively, in other embodiments, each actuator comprises an electro-active polymer. In such embodiments, the plurality of electrical conductors supplies an electrical potential that is applied across each actuator that is to be activated. The electrical potential causes an ion migration within the electro-active polymer that changes the shape of the actuator, producing a force that bends a distal portion of the elongate imaging probe. It is apparent that still other types of actuators might be used to provide the mechanical force that bends the elongate imaging probe.

This Summary has been provided to introduce a few concepts in a simplified form that are further described in detail below in the Description. However, this Summary is not intended to identify key or essential features of the claimed subject matter, nor is it intended to be used as an aid in determining the scope of the claimed subject matter.

### DRAWINGS

Various aspects and attendant advantages of one or more exemplary embodiments and modifications thereto will become more readily appreciated as the same becomes better understood by reference to the following detailed description, when taken in conjunction with the accompanying drawings, wherein:

FIG. 1 illustrates the distal end of an exemplary flexible scanning fiber endoscope (SFE) that can be provided with a distal tip bending mechanism in accord with the present approach;

FIG. 2 illustrates an exemplary image of an in-vivo pig airway taken with the flexible SFE of FIG. 1;

FIG. 3 is a schematic illustration showing segment coordinates definition and trigonometric relationships between bending angle/radius and deflection of the distal end of an exemplary flexible imaging probe;

FIG. 4A is an image showing an experimental arrangement for testing the exemplary imaging probe shaft bending with the two distal segments of shape memory alloy (SMA) activated;

FIG. 4B is a diagram illustrating a shaft bending simulation for an exemplary imaging probe with two distal segments of shape memory alloy (SMA) activated;

FIG. 5A is a schematic diagram illustrating shaft bending (20 mm bend radius) of an exemplary imaging probe, where the circles indicate the distal tip of the imaging probe and there is one module (where a module is defined as an independently controllable series of segment actuators; in other words, a group), with six actuators, providing up to 180° of tip bending;

FIG. 5B is a schematic diagram illustrating shaft bending (20 mm bend radius) of an exemplary imaging probe, where the circles indicate the distal tip of the imaging probe and there are three modules, with two links (actuators) each, providing a maximum 180° bending;

FIG. 6A is a schematic diagram illustrating the distal portion of an exemplary imaging probe provided with two groups of two actuators each, before any actuator is selectively activated;

FIG. 6B illustrates the distal portion of the exemplary imaging probe after the proximal actuator of the more distal group has been selectively actuated, showing how the distal tip of the imaging probe has been deflected as a result of the force provided by the actuator;

FIG. 7 is a schematic diagram illustrating the distal portion of an exemplary scanning fiber imaging probe provided with two groups of two actuators each, before any actuator is selectively activated, wherein each actor comprises a helical coil of a shape memory alloy;

FIG. 8A is a schematic diagram of an exemplary optical fiber scanner that includes a plurality of peripheral reflection return optical fibers for conveying light proximally to a plurality of light sensors;

FIG. 8B is an alternative exemplary optical fiber scanner that includes a plurality of peripheral light sensors, which are responsive to light received from the surface, producing electrical signals used for imaging the surface;

FIG. 9A is a schematic diagram illustrating an exemplary relaxed volume, e.g., a bladder that is generally empty of urine;

FIG. 9B illustrates the volume of FIG. 9A after the volume has been distended by injection of a fluid under pressure, in preparation for imaging of the internal surface of the volume;

FIG. 10A is a schematic illustration showing the volume of FIG. 9B being imaged at three initial positions, including an initial position with the distal tip of the imaging probe not deflected in an arc, and two other positions with the distal tip deflected through an initial arc;

FIG. 10B is a schematic illustration showing the volume of FIG. 9B being imaged at two positions, after the distal tip of the imaging probe has been deflected through a substantially greater arc;

FIG. 11A is an exemplary schematic image of a surface of a volume, showing how part of the surface that has not been included in the image is visually evident to a user;

FIG. 11B is a schematic illustration showing a display (at a time t_{A}) on which a composite image of the internal surface of a bladder is mapped onto a 3-D model that is being rotated about the vertical axis of the model;

FIG. 11C is a schematic illustration showing a display (at a time t_{B}) on which a composite image of the internal surface of a bladder is mapped onto a 3-D model that is being rotated about the horizontal axis of the model;

FIG. 11D is a schematic illustration showing a display (at a time t_{C}) after the 3-D model has been rotated 180° about the horizontal axis of the model, relative to the view in FIG. 11C, indicating how a portion of the surface that was not scanned is visually evident to a user observing the display;

FIG. 12A is a schematic diagram showing how an external magnetic field generator is disposed to enable a sensor disposed proximate to the distal end of an imaging probe to sense its position and orientation so as to provide an indication of the disposition of the distal end of the imaging probe when imaging the surface of the volume;

FIG. 12B is a schematic diagram like that of FIG. 12A, but using a miniature magnetic field generator disposed proximate to the distal end of the imaging probe to produce a magnetic field that is detected by an external sensor that produces a signal indicative of the imaging probe;

FIG. 13 is a schematic diagram illustrating an exemplary positioner that is usable to control an insertion depth and a rotational position of an imaging probe within a volume in response to control signals provided by a controller;

FIG. 14 is a schematic diagram that illustrates how a plurality of discrete overlapping images of a surface within a volume are combined to create a composite overall image of the surface, e.g., using a software program to stitch together the discrete images;

FIG. 15 is an exemplary functional block diagram illustrating the functional components and signal flow in an imaging system that is coupled to an imaging probe having a distal end that can be selectively deflected in a desired arc, for use in imaging a surface within a volume, and for automatically positioning the imaging probe within a volume so as to image substantially all of at least a desired portion of the surface within the volume;

FIG. 16 is a schematic diagram of a female reproductive system, illustrating the different manner in which the surface of one of the fallopian tubes is imaged at different insertion depths and cross-sectional diameters of the fallopian tube;

FIG. 17 is a schematic illustration of a display on which a composited image of fallopian tube is mapped onto a model that is continuously rotated about its longitudinal axis;

FIG. 18 is an exemplary schematic illustration of a non-medical application, showing how the internal surface of a cylinder to other shape tank can be scanned to detect defects in the surface;

FIG. 19 is a schematic illustration of a display showing how a composite image of the inner surface of the cylinder of FIG. 18 can be mapped onto a cylindrical model that is rotated about either or both the orthogonal X and Y axes

FIGS. 20A and 20B respectively schematically illustrate a cross-sectional view and an end view of a multimode optical fiber of the type used for a reflection return optical fiber in an exemplary embodiment of an imaging probe, showing how axially spaced-apart Bragg gratings formed in the multimode optical fiber and used as strain sensors can be employed for optically sensing the shape, position, and orientation of the reflection return optical fiber, and thus, of the imaging probe; and

FIG. 21 is a graphical illustration showing how the strain sensors in each core of the multimode optical fiber are used to produce strain measurements for determining a 3-D position and orientation of the multimode optical fiber in a shaft of a flexible imaging probe that is being bent in an arc.

### DESCRIPTION

### Figures and Disclosed Embodiments are not Limiting

Exemplary embodiments are illustrated in referenced Figures of the drawings. It is intended that the embodiments and Figures disclosed herein are to be considered illustrative rather than restrictive. No limitation on the scope of the technology and of the claims that follow is to be imputed to the examples shown in the drawings and discussed herein.

Scanning Fiber Endoscope with Tip Bending Mechanism

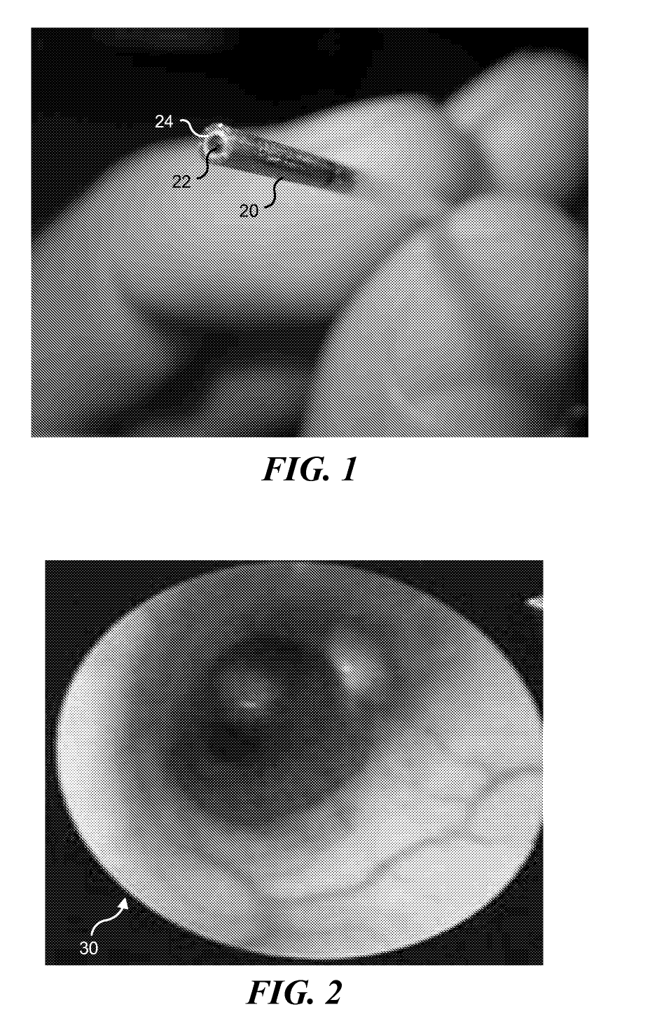

As shown in FIG. 1, a 1.6 mm diameter scanning fiber endoscope (SFE), which is usable in an imaging probe having a remotely controlled distal end that can be deflected through a desired arc, has been developed at the University of Washington. With a rigid 13 mm long micro-optical scanner 20 at the distal tip, this current design produces full color and higher pixel-count images than do conventional fiber-optic imaging bundles. The scanner of the SFE includes a tubular piezoelectric actuator that is disposed around a singlemode optical fiber to vibrate the distal tip of the optical fiber at or near its resonant frequency (about 5 KHz) to scan laser illumination of an internal site. Surrounding the central vibrating fiber scanner and a 70-degree objective lens assembly 22 are twelve 250-μm multimode fibers 24 that are used for collecting the time-multiplexed backscattered signal. Further details regarding this scanning fiber endoscope are discussed below. FIG. 2 is an exemplary image of an in-vivo pig airway taken with the SFE of FIG. 1. To avoid confusion in regard to the term “scanning,” it is important to understand that the SFE includes a scanning optical fiber that scans a region of an adjacent surface with light while the SFE is oriented in a given position and orientation, to produce an image of that portion of the surface (or subsurface). In addition, the surface or subsurface is also scanned with the SFE by moving it to different positions and orientations, so that additional images of the surface (or subsurface) can be produced by the SFE using the vibrating optical fiber of the SFE to scan at each different position and orientation of the SFE.

Three main features were introduced to create a novel low-cost bladder screening device based on a completely new type of endoscope imaging technology. While the initial motivation to develop this device was for use in bladder screening, it must be emphasized that this new device is usable both for other types of medical applications and for non-medical applications that can benefit from being able to insert a small diameter imaging probe through a small opening to scan an internal surface and/or subsurface of a relatively larger volume.

New approaches and technologies for providing low cost tip bending and a steerable shaft mechanism are essential to maneuver the ultrathin and flexible SFE into a desired position and orientation. A new approach to manual control of the SFE imaging at the proximal end is using the central optical fibers as the compression element and the surrounding optical fibers as tension bearing cables (as taught in commonly assigned U.S. patent application Ser. No. 12/025,342, filed Feb. 4, 2008). Due to the small moment arm in the limited space of the SFE shaft, tip bending requires a high force, low strain actuator, such as shape memory alloy (SMA) wire. SMA provides high force generation versus weight ratio compared to other smart materials and is thus an attractive choice for use at this micro-to-meso scale. However, there are other materials that can instead be used to produce the mechanical force adjacent to the tip employed for bending the distal end of the imaging probe through a desired arc. One alternative class of actuators includes shape memory polymers (SMPs), which are activated by heating. Another alternative class of actuators includes electro-active polymers (EAPs), which are activated by application of a voltage across the polymer, causing an ionic migration that bends the polymer material and thus, bends the imaging probe. Although many EAPs require a relatively high activation voltage to produce this effect, new types have been developed that can be activated at much lower voltage that is entirely safe for use in a patient's body. Still other types of actuators might be used, such as fluid-filled bladders disposed along a side of the flexible shaft of an imaging probe and are controllably filled with fluid under pressure to bend the distal tip of the flexible shaft.

### Methods

A single-axis three-step graded bending motion of a 2-mm OD imaging probe has been demonstrated by constructing a prototype using an SFE with SMA actuators disposed adjacent to the distal tip of its flexible shaft. This prototype imaging probe uses an electrically multi-tapped SMA wire (Flexinol™, 90-mm, 125 μm OD), which is attached to one side of the SFE probe tip. A demultiplexer (model DG408DJ™, available from Maxim, Sunnyvale, Calif.) decodes one-of-eight lines and modulates metal oxide semiconductor field effect transistors (MOSFETs) that control application of electrical current to the SMA wire segments, based upon the conditions at the three binary select inputs that are provided by LabVIEW™ software (available from National Instruments, Austin, Tex.). The controlled SMA segments contract stepwise according to the number of actuated sections. When the contracted SMA segments are heated above the transition temperature of the SMA by the resistive heating of electrical current flowing in the segments, a bending motion of the imaging probe results due to the 1 mm moment arm.

For a simple two-dimensional (2-D) cantilever bending configuration, the relationship between the bend radii and the strain (contraction) of the innermost part of a segment is shown below by Eq. (1). Note that ε indicates the strain of the innermost side, and t denotes the diameter of the object being bent. The parameters R, rₙ, and r, are the outermost, neutral, and innermost radii, respectively, and φ is the bending angle.

$$ɛ = \frac{( R - {r}_{n} ) ϕ}{{r}_{n} ϕ} = \frac{t / 2}{r + ( t / 2 )} \qquad ( 1 )$$

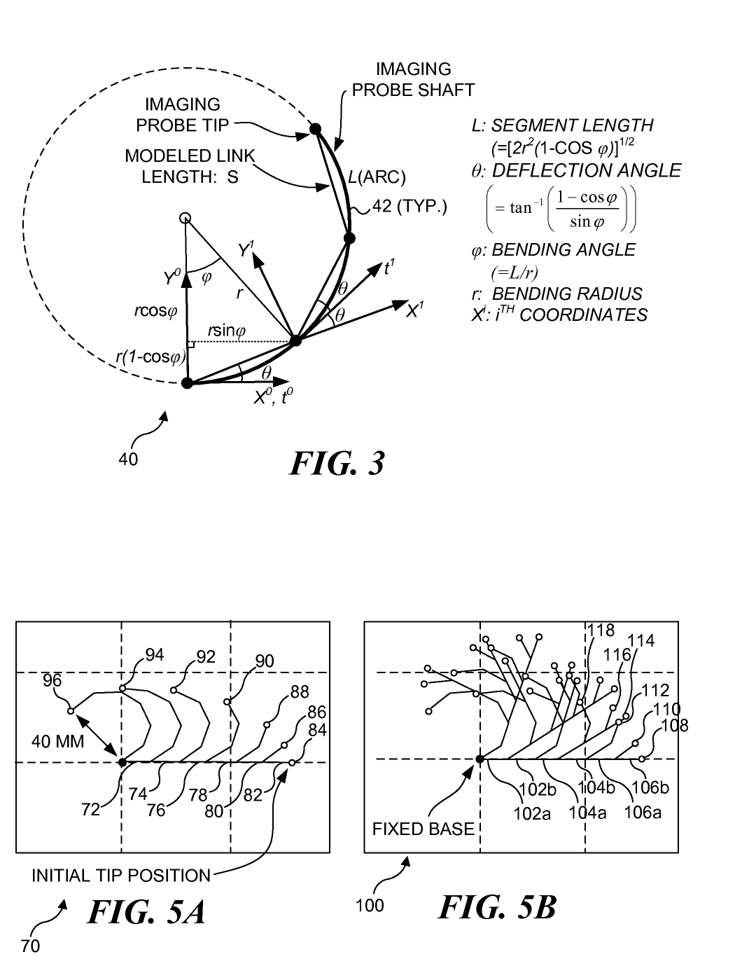

In Eq. (1), the bending angle (φ) cancels out, indicating that strain and thickness are the only determining factors of the bend radius. Therefore, adding to the activated length only increases the bending angle, while the bend radius remains the same. In order to simulate graded motion of the SFE tip bending, the kinematics were modeled as a multi-link planar manipulator and forward kinematics were programmed in the MATLAB™ software program (available from MathWorks, Inc., Natick, Mass.). The basic relationship between the bending radius, the bending angle, and the deflection angle is illustrated in FIG. 3 for a three-segment model 40 of an SMA activated shaft with a most distal modeled actuator 42.

### Results

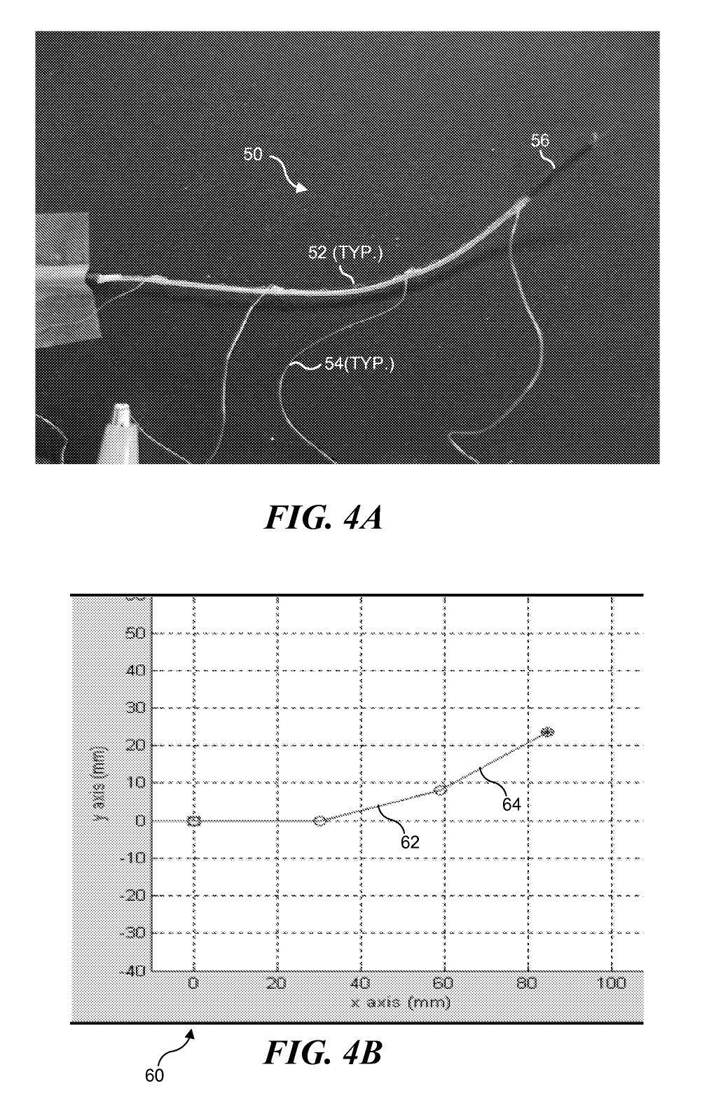

Experimental results were obtained for an exemplary embodiment of an SFE 50 (FIG. 4A) that is provided with three SMA segments 52 attached adjacent to its distal end 56 (two segments are activated in the illustration of FIG. 4A). These segments are selectively activated by applying an electrical current through appropriate specific leads 54 (including three leads that are selectable as a ground lead and the distal lead that is connected to power) to energize 1, 2, or all 3 segments of the SMA. Simulation results 60 of a three-segment model with two segments 62 and 64 activated are shown in FIG. 4B. The experimental results obtained with SFE 50 and the simulation results are summarized below in Table 1, for an initial tip location (X=90 mm, Y=0 mm). A minimum bend radius of 45 mm and a 500 deflection angle is generated with retraction from elastic sheathing, when the three segments are activated.

TABLE 1

| | | |
|---|---|---|
| Tip location (mm) | Experimental | Simulation |

| Activated segment | X | Y | X | Y |
|---|---|---|---|---|
| 1 only | 88.3 | 9.6 | 88.9 | 8.0 |
| 1 & 2 | 85.7 | 20.7 | 84.6 | 23.5 |
| 1 & 2 & 3 | 63.6 | 37.2 | 75.3 | 45.3 |

For the multi-segmented bending mechanism, the manipulation is mainly determined by the degrees of freedom and number of segments. To avoid too much complexity in the interface circuit and manufacturing of a prototype imaging probe, some assumptions were made. First, each segment bends to only one side (positive deflection). Second, graded bending motion always starts from the distal side; e.g., out of possible eight mode shapes of the three-segments, only four modes are utilized. Third, each link has the same length (L) and the same deflection angle (θ). Initial selection of the parameters such as length/number of segments and the stiffness of the shaft can specify the position and the orientation of the imaging probe tip to approach a desired point in the workspace. A multi-module structure (where module is defined as an independently controllable series of segments) covers wider locations in space than a single module system with the same number of segments, although the former must have more complex interface circuits and longer length. Tip location is modeled for a 2 mm diameter imaging probe in FIGS. 5A and 5B, to compare performance when using a single-module (FIG. 5A) versus three-module (FIG. 5B) configuration. In FIG. 5A, a model 70 illustrates segments 72, 74, 76, 78, 80 and 82 initially undeflected so that the distal end is at a position 84, and then with successively more of the segments activated so that the distal end is deflected successively to positions 86, 88, 90, 92, 94, and 96. At position 96, the distal tip orientation is deflected through more than 180 degrees. FIG. 5B illustrates a model 100 having three modules with segments 102a and 102b, 104a and 104b, and 106a and 106b. When no segment is activated, the distal tip is at a position 108. When only segment 106b is activated, the distal tip is deflected to a position 110. Activation of both segments 106a and 106b deflects the distal tip to a position 112. Activation of segment 104b deflects the distal tip to a position 114 and if segment 106b is also activated, the distal tip is deflected further to a position 116. If segments 104b, 106a, and 106b are activated, the distal tip moves to a position 118. The Figure shows each other position for the distal tip as other segments are selectively activated.

### Discussion

The 2-mm imaging probe prototype with SMA active tip bending provides a clinically acceptable 500 deflection angle, while future 1 mm imaging probe designs are expected to reduce the minimum bend radius by a factor of two. The major problem of having a series of segmented actuators is the number of control/power wires. The design described above, which includes multi-tapped continuous SMA wire, integrated with a complementary metal oxide semiconductor (CMOS) interface circuit can reduce the number of wires significantly, but that option is not a requirement to achieve the desired capability to deflect the distal end of an imaging probe.

Advantages of Imaging Probe with Tip Bending Capability

First, the novel design of the exemplary imaging probe, (such as one using the SFE, which is shown in FIG. 1) disclosed herein promises to provide an ultra-thin optical imaging and diagnosis tool without sacrificing image quality. This imaging tool also guarantees full color, high scanner frame rate (>15 Hz), more than a 70 degree field-of-view, and long working distance configuration. The prospective 1.0 mm diameter of this SFE may reduce the need for anesthesia and dilation during endoscopic procedures employing the new device. However, alternative imaging technologies that provide imaging from within a flexible conduit of less than 3 mm in diameter can be used, but are expected to be of lower performance and higher cost than the SFE technology probes. These alternative imaging technologies include video endoscopy with a charge coupled device (CCD) or complementary metal oxide sensor (CMOS) camera sensor disposed at the distal or proximal end of an ultrathin and flexible conduit.

Second, the multi-segmented shape memory alloy (SMA) active tip bending/navigation mechanism is integrated with a small diameter imaging probe. Controlling the individual segment with digital/analog communication can manage gradual motion of the imaging probe shaft. In addition, a single (or multi) axis multi-step graded bending motion of the imaging probe can be demonstrated by an electrically multi-tapped SMA wire (or sinusoid or helix), which is attached to one side of the imaging probe tip. The controlled SMA segments contract stepwise according to the number of actuated sections. Initial selection of the parameters such as length/number of segments and the stiffness of the shaft can specify the position of the imaging probe tip to approach a desired point in the workspace. A multi-module structure covers wider locations in space than a single module system with the same number of segments, although the former must have more complex interface circuits.

The automated continuous and optimal scanning path of the imaging probe with tip bending capability, which is unlike the more random cystoscopic observation by clinicians, guarantees that each local internal surface of the bladder is substantially fully inspected in a controlled and uniform manner. This path can be displayed using two separate motions of the imaging probe tip, graded bending and rotation. As all urine is drained out, and the bladder and ureters are filled with saline fluid under pressure during the ureteroscopic/cystoscopic procedures, the bladder is inflated, and it resembles a sphere with about a 10-15 cm diameter.

FIG. 9A illustrates a bladder 350′ that has been emptied of urine. FIG. 9B illustrates a catheter 360 that is coupled to a source of pressurized fluid and pump 356 to distend the surface with fluid 354. The fluid will typically be a saline solution that is conveyed through catheter 360, which is inserted into urethra 352. A similar process might be used for volumes in other applications, and in this regard, urethra 352 can be viewed simply as a small diameter opening into the relatively larger volume 350′. Similarly, although the urethra will provide the necessary seal around the catheter, for other applications, a plug 358 might be inserted into the opening to seal the volume as the fluid is inserted under pressure, causing the surface to be distended as shown for a volume 350. Alternatively, plug 358 may include a valve (not shown) that simply limits the rate of fluid flow exiting the volume. For example, the valve might control the flow rate of an irrigating saline solution that is used to continually flush the bladder, while maintaining the bladder at a desired volume and at a desired temperature. Furthermore, bladder distension may be controlled during the scanning procedure, if more than one volume of the bladder is required during the procedure, by appropriately controlling pump 356, which is supplying the fluid under pressure.

It is assumed that the complete scanning takes place over a relatively short interval of time and that the moving tip of the imaging probe is located at the designated points along a trajectory (which can be calculated from the design tool discussed above). Options for the target path are discussed in the next paragraph, below.

It is VERY important that imaging of the surface of a bladder to detect problems such as cancer be complete and include substantially the entire surface, since the occurrence of a tumor on a small portion of the surface that is not imaged and is thus overlooked, can have serious and even life threatening consequences to the patient, and give rise to potential medical malpractice liability for the medical practitioner carrying out the imaging procedure. The use of a thin endoscope with distal tip bending for the imaging probe can enable a medical practitioner to readily ensure that images are produced for substantially the entire surface of the bladder, as explained below. This process can be manually controlled by a medical practitioner having complete knowledge of the surface and the location of the points adjacent to the surface where the distal end of the imaging probe must be positioned by controlling the insertion depth, the rotation, and the arc through which the distal end of the imaging probe is deflected. Alternatively, an automated controller can be programmed to position and orient the imaging probe by controlling one or more of these three parameters, perhaps in cooperation with the medical practitioner controlling the other parameters, so as to ensure that images of the surface are produced at all points necessary to image the entire surface. The skilled practitioner can also determine if the image quality meets some predefined level, or that determination can be carried out automatically. In either case, the user can manually position and orient the imaging probe or the imaging probe can be automatically positioned and oriented to reimage any portion of the surface where a previous image was not of the predefined quality.

Several different procedures can be used to control the points at which images of the surface are produced during the scanning process. One option, the spiral trajectory, effectively covers the surface of the somewhat spherical bladder. A continuous movement of the scanner tip along the spiral path from the northern pole (the farthest point from the urethra entrance) to the southern pole (which is proximate to the urethra entrance) will scan all regions of the inner sphere of the bladder. The relatively simple concepts of spherical coordinates and rotation matrices can be used in the mathematical construction employed for manual and/or automated control of the imaging probe. One variation of the spiral trajectory is the latitude trajectory. The latitudinal circular scanning obtained by a 360 degree rotation of the shaft and discretely controlled vertical bending motion will also sufficiently cover the whole surface of the bladder. Over scanning at both poles can be prevented by simply resetting the sampling density (a time variable) from t to sqrt(t). A parametrically defined imaging probe trajectory enables the accurate and systematic scanning of the entire surface of the bladder. This method requires only one axis bending and thus, will be beneficial to minimizing the total cross-sectional size of the shaft of the imaging probe and ease of manufacturing it.

The other option is called the longitudinal trajectory. This option is designed to approach the poles multiple times from different directions and will provide a clearer and more thorough view of the bladder entrance. This method needs at least three bending mechanisms disposed 120 degrees apart (or at equal angular increments if more than three bending mechanisms are used) on the outer surface of the shaft of the imaging probe, to enable the shaft to be bent in six directions by a combination of the three or more actuators. One whole graded bending and retracting motion per axis completes a loop from the northern pole to the southern pole, and returning to the northern pole. This method doesn't require any rotational motion of the imaging probe shaft.

There are many commercially available SMA materials, such as Nitinol, and they can be purchased in different shapes such as wire, springs, thin sheets, and small tubes. If needed, the SMA can be deformed (programmed) by the user for a specific purpose, adjusting strain/force and transition temperature. The large strain/force and a large flexibility of design are considered to be advantages for designing a flexible bending mechanism. Unlike competing elastomeric polymers and some electro-active polymer actuators, the force generation of SMA material is very high, typically 10 to 100 times greater than that of polymer-based actuators. Despite the limitations of use of SMA materials, such as the relatively slow response time, the nonlinear hard-to-control hysteresis, and heat generation, SMA was chosen as the “best choice” material for making the scanning mechanism of the initial exemplary ultrathin and flexible cystoscope, with appropriate designs being employed, due to the most important factors, i.e., large force generation and strain.

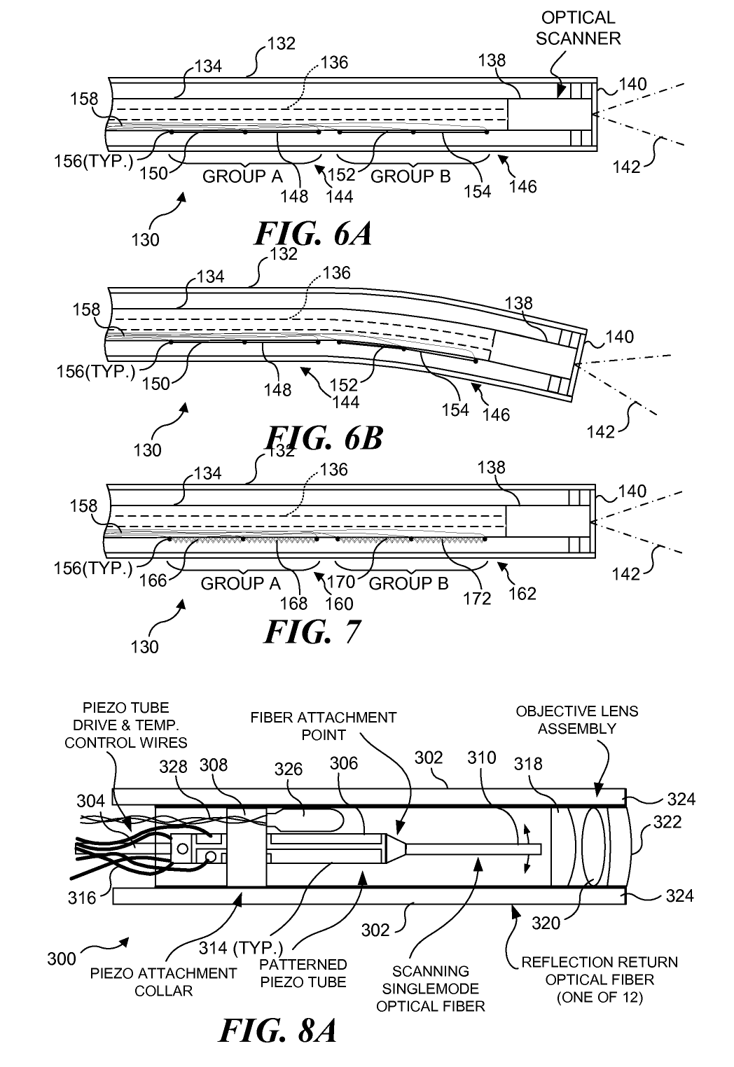

FIGS. 6A and 6B illustrate a flexible imaging probe 130 that is protected by a flexible sheath 132, within which is disposed an SFE 138 at the distal end of a shaft 134. (It will be understood that other types of imaging devices beside the SFE could be used in the exemplary embodiments illustrated in FIGS. 6A, 6B, and 7.) An optical fiber 136 used for scanning a surface with light extends through shaft 134. Details of the SFE are disclosed below. Light 142 emitted by the scanning optical fiber passes through an optically transparent window 140 that seals the distal end of sheath 132. Two groups 144 and 146 of SMA actuators are used to produce a mechanical force that deflects the distal end of imaging probe 130 to bend through an arc, as shown in FIG. 6B, relative to its undeflected state, which is shown in FIG. 6A. Two segments 148 and 150 comprise group 144 (also identified as Group A in the Figure), while two segments 152 and 154 comprise group 146 (also identified as Group B). Any of these segments can be selectively activated by providing an electrical current to heat the segment through leads 158 that run longitudinally within shaft 134 and are connected to nodes 156, which are disposed at the ends of each of the segments. In FIG. 6B, only segment 152 has been activated, which deflects the imaging probe through a relatively shallow arc. Alternatively, although not shown, the leads carrying current to each segment to be actuated can be disposed within sheath 132, outside the shaft and externally connected to nodes 156.

It must be emphasized the actuator segments used to deflect the distal end of an imaging probe can be fabricated with different forms of SMA, such as helical coils, zigzag shapes, etc., as well as formed in other shapes and from other materials, such as a cylinder of an electro-active polymer or piezoelectric material. For example, FIG. 7 illustrates imaging probe 130 with an alternative actuator comprising two groups 160 and 162, where group 160 includes two segments 166 and 168, and group 162 comprising segments 170 and 172 that are formed of helical coils of SMA wire. This alternative form of the actuator segments is the only difference between the exemplary embodiment shown in FIGS. 6A and 6B, and that shown in FIG. 7.

While it is acceptable to view discrete images of a surface to identify characteristics of interest, it can be easier to recognize such characteristics when viewing an overall image of the surface as a composite image. Another advantage of the present technology takes advantage of the rectified surface mosaics technique that has been developed by others, which enables distortion-free mosaics to be created for any developable surface. An exemplary technique for creating such mosaics is disclosed in commonly assigned U.S. patent application Ser. No. 11/749,959, which was filed on May 17, 2007. Commercially available software, such as AUTOSTITCH™, which was developed by M. Brown and D. G. Lowe can be used for creating the mosaic from the discrete images of the surface. The resulting mosaic image of a bladder internal surface has the same parameterization as the bladder surface itself. The software used to implement creation of the mosaic image stitches together a video sequence of discrete images of an approximately spherical structure into either a flat mosaic image or a three-dimensional (3-D) reconstructed image (e.g., shown on the inside or the outside of a sphere). A schematic example shown in FIG. 14 illustrates how a plurality of overlapping discrete images 480 of a surface can be combined with readily available software to form an overall composite image 482 of the surface. Mosaics thus enable capturing the appearance of an entire scene in a single composite image. For complete accuracy, the form of the surface must be known in advance, but the camera path may be unknown and unconstrained.

Since the mosaic image is based on the cystoscopic real video sequence, it can depict some smaller regions (<5 mm) that may not be seen on the transverse CT images (2-D perspective). In addition, this technology can provide all of the information regarding the surface, such as the surface and subsurface mucosa color and texture changes, which are not available in virtual cystoscopy. Furthermore, new fluorescent indicators are high contrast molecular probes for the earliest cancers, which can be used in the fluorescent mode of the SFE. Some research proves that the recent advances in fluorescence cystoscopy have improved bladder cancer detection, especially for small, flat or papillary lesions compared with the standard white light reflectance video imaging. The stitched bladder surface image constructed in 3-D from reflectance or fluorescence video can be rotated in all directions in space, enabling a quick but complete and authentic analysis of the overall urothelium in the wall of the bladder. This capability should greatly decrease the time needed to make a diagnosis and should give a clearer picture of a patient's condition. In addition, this technology will provide urologists with a tool to easily visualize a patient's entire bladder surface at once, ensuring that substantially the entire surface is imaged, to avoid overlooking any small problem area(s).

It must be emphasized that an imaging probe with tip bending capability is not limited for use only in the bladder and upper urinary tracts, including the ureters and kidney drainage. It can also be used in other medical or veterinary imaging applications. Exemplary applications in medicine are entering the stomach from the esophagus and scanning its inner surface, entering the colon through the anus, scanning the sinus cavities, and scanning the uterus and fallopian tubes for early signs of cancer. In the case of the fallopian tube, which has the shape of a deep-throated flower, the method of fully scanning the epithelial surface may not involve scanning at the small proximal end, but instead, the scanning may be mid-way along the tube, with the probe tip deflecting side-to-side, and near the wide distal opening at the ovaries, a full spiral scan trajectory may be necessary. When viewed, the composite image of the fallopian tube may be mapped onto a surface that resembles the 3D morphology of a deep-throated flower to assist the clinician to visually see if any surface area was inadvertently not scanned. Since many surgical openings for medical imaging and image-guided interventions are small, there are many additional applications that would require surgery for insertion of the imaging probe, such as scanning the heart, brain, and many abdominal and thoracic cavities.

The combination of the scanned imager and visualization feature can also be used in non-medical applications. It should be evident that an imaging probe (such as one that includes the novel SFE) with an optimum scanning trajectory and using the mosaic algorithm to “wallpaper” the expected 3D shape with the composite image can also be used outside medical practice as a borescope to remotely inspect, tanks, cylinders, pipes, engines, machines, or any structure with known geometry either through an existing opening or through a bored hole. Furthermore, the approach described above can be applied to the active bending of any autonomous small device or device attached to a long-flexible shaft device, such as a cannula or guidewire. Thus, a scan made inside a volume with an ultrasonic probe that is remotely positioned and oriented by controlling its insertion depth, rotation, and/or the bending of the distal portion of the probe can thus achieve complete coverage of a surface and/or subsurface.

Exemplary Imaging Devices with Return Optical Fibers, or Distal Light Sensors

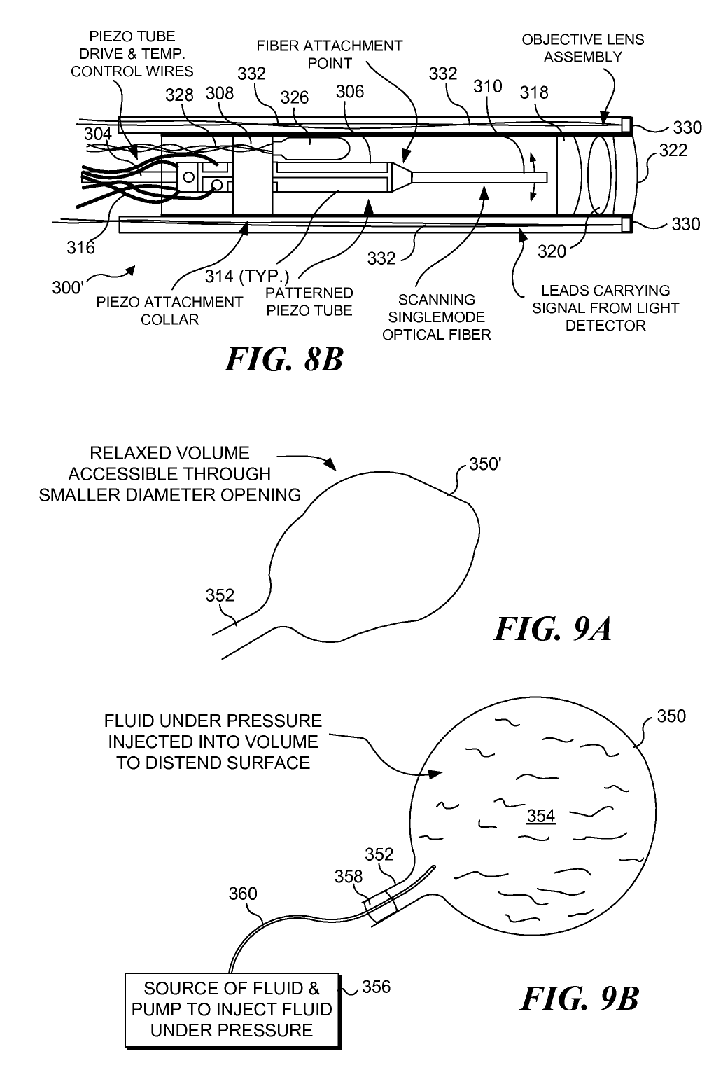

While other designs for imaging devices can be employed in a thin endoscope or imaging probe, one example comprising an SFE 300 is illustrated in FIG. 8A. SFE 300 includes a flexible single mode optical fiber 304 that passes through a patterned tube of piezoelectric material 306, which electrically energized with an appropriate signal, serves to drive a distal end 310 of the optical fiber to move in a desired scanning pattern. Distal end 310 extends distally beyond the patterned tube of piezoelectric material and is cantilevered from it, adjacent to a distal end of the tool or other component on which the SFE is mounted or supported. The patterned tube of piezoelectric material is held in place by a piezo attachment collar 308. Quadrant electrodes 314 are plated onto the patterned tube of piezoelectric material and can be selectively energized with an applied voltage in order to generate two axes of motion in distal end 310 of optical fiber 304. Lead wires 316 carry electrical voltage signals to each of the quadrant electrodes to energize the piezoelectric material relative to each axis of motion and also may convey a temperature control signal to a temperature control (not shown). In this exemplary embodiment, the two axes in which the distal end of the optical fiber are driven are generally orthogonal to each other. An amplified sine wave electrical signal applied to one axis and a cosine wave electrical signal applied to the other axis of the patterned tube of piezoelectric material can generate a circular scan of the cantilevered distal end of the optical fiber, although those of ordinary skill in the art will understand that a variety of different scan patterns can be produced by applying different electrical signals for appropriately moving distal end 310 of optical fiber 304. An appropriate modulation of the amplitudes of the electrical voltage signals applied to the quadrant electrodes can create a desired area-filling two dimensional pattern for imaging the surface of a volume with light emitted from distal end 310 of the optical fiber. A few examples of the various scan patterns that can be achieved include a linear scan, a raster scan, a sinusoidal scan, a toroidal scan, a spiral scan, a propeller scan, and a Lissajous pattern. In some embodiments, the distal end of the optical fiber is driven so that it moves at about its resonant (or near-resonant) frequency, which enables a greater scan amplitude to be achieved for a given level of drive signals applied.

Other types of imaging devices that can alternatively be used for imaging at the distal end of an imaging probe include a MEMS scanner (not shown) that has a scanning beam used to optically scan a surface with light to produce an image of the surface. An example of a MEMS scanner for imaging is shown in commonly assigned U.S. Pat. No. 6,975,898, the disclosure and specification of which are specifically hereby incorporated herein by reference. A reflective mirror can also be driven to scan a site with light conveyed to the distal end of an imaging probe, as will be known to those of ordinary skill.

Light emitted from distal end 310 as it moves in the desired scan pattern travels through lenses 318, 320, and 322 and is directed at a surface forward of the SFE. The overall diameter of the SFE is typically 1.0 mm or less. Light reflected or scattered by the portion of the surface that was thus illuminated with the scanning light is then detected and used to provide the imaging function. In this exemplary embodiment, an annular ring of twelve return optical fibers 302 is disposed around the distal end of the SFE and has a typical outer diameter that is less than 2.0 mm. Light from the site passes into distal ends 324 of the return optical fibers and is conveyed proximally to detectors in a base station (not shown in this Figure). The output signals produced by the detectors are then used to produce an image of the portion of the surface that is proximate to the distal end of the SFE.

FIG. 8B illustrates an alternative exemplary embodiment of an SFE 300′, which is identical to that of FIG. 8A, except that instead of using reflection return optical fibers 302, SFE 300′ includes a plurality of light detectors 330 that are arranged peripherally around lens 322 to receive light from the surface being imaged. The light detectors produce corresponding output signals that are conveyed through leads 332 toward the proximal end of the imaging probe, where the signals can be processed to produce a corresponding image of the surface that is illuminated by the SFE. Alternative embodiments of the SFE can be configured for side viewing instead of forward viewing, for example, by adding a reflective 45-degree mirror or prism at the distal tip to direct light emitted from the scanner toward the side of the distal tip. Other types of subsurface imaging modalities can be used with the SFE such as confocal fluorescence and optical coherence tomography (OCT). Typically these modalities image the surface and subsurface layers of translucent volumes depending on the depth of focus of the optical illumination within this volume. However, fixed depth plane imaging below the tissue surface is possible for both fluorescence and OCT modalities as disclosed in commonly assigned U.S. patent application Ser. No. 10/880,008, filed Jun. 28, 2004.

In both embodiments 300 and 300′ of FIGS. 8A and 8B, a position sensor 326, which is disposed adjacent to the distal end of SFE 300, measures the orientation and position of the distal end of the imaging probe within five or six degrees of freedom. It must again be emphasized that position sensor 326 can be similarly disposed within and used for this purpose with other types of imaging devices in an imaging probe. Electromagnetic sensors range is size from about 0.3 mm in diameter and larger for 5-degree-of-freedom sensors and about 1.3 mm in diameter and larger for 6-degree-of-freedom sensors, such as those that are available from Ascension Technology Corp. (Burlington, Vt.). The exact location of the position sensor 326 within the rigid portion of the SFE tip is not critical, since the calibration after fabrication will correlate sensor measurement with relative orientation and position of the imaging field. Leads 328 are coupled to position sensor 326 and extend proximally. The signals conveyed by leads 328 are input to a controller (not shown in this Figure) and provide an indication of the position and orientation of the SFE within a volume into which it has been inserted, e.g., relative to the surface of the volume. When a user (and/or an automatic controller) is provided with information indicating the position and orientation of the distal end of the SFE relative to the surface being imaged, the SFE can be either manually or automatically controlled and positioned at each of a plurality of different positions selected so as to ensure that at least a desired portion of the surface of the volume is substantially fully imaged.

Using a model of the three-dimensional shape of the surface of the volume that is to be imaged, it is relatively simple to determine a plurality of probe tip positions and orientations at which images of the surface should be produced so as to ensure the all or some desired portion of the surface is fully imaged. These positions will typically be spaced apart from each other and at a defined working distance from the surface, which can be correlated to the depth of focus. It may be desirable to select the position so that discrete images of the surface produced at adjacent points slightly overlap, to facilitate creating an overall composite image of the surface. Alternatively, a person may have sufficient knowledge or experience to determine the positions at which images of the surface should be produced using the imaging probe to ensure that the entire surface or at least a desired portion of it is fully imaged by producing images using a series of probe tip maneuvers, typically from manual control of the proximal end by the experienced person. Thus, the person using the imaging probe can manually position, rotate, and selectively activate actuators to produce the mechanical force required to bend the distal end of the scanning fiber probe to position and orient it at each successive position to image all or at least the desired portion of the surface. These manual motions can be recreated and automated by robotically automatically controlling the proximal end of the imaging probe.

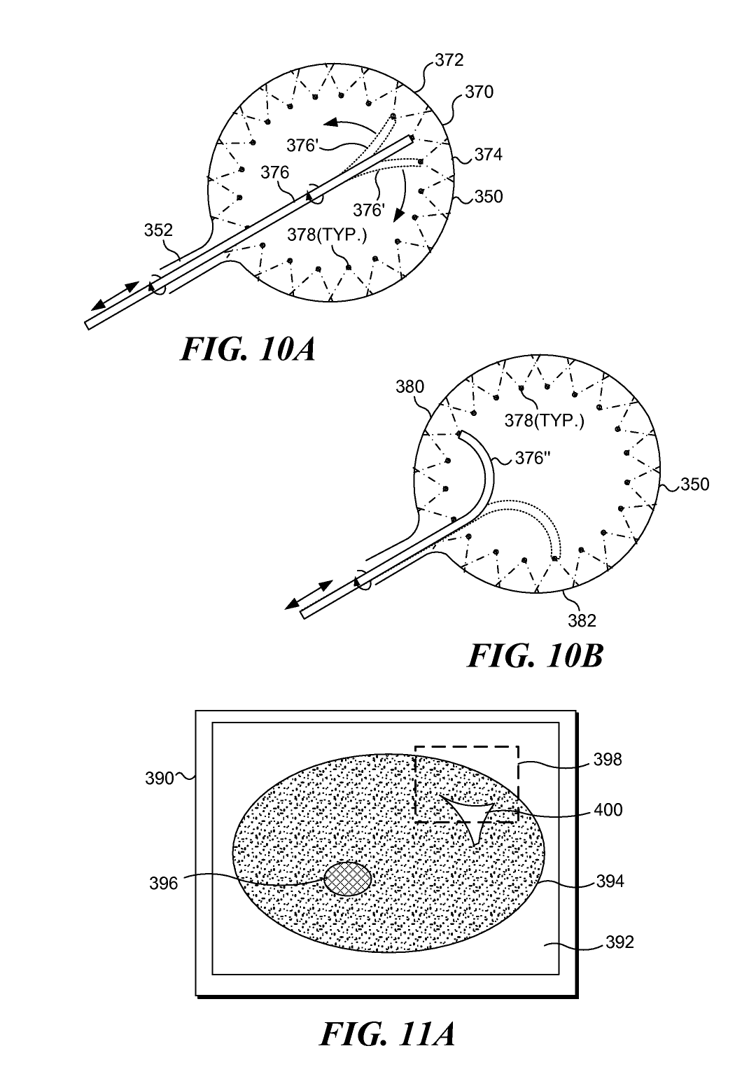

FIGS. 10A and 10B illustrate one exemplary approach for controlling the position and orientation of the imaging probe to ensure that substantially the entire inner surface of a volume 350, such as a patient's bladder, is scanned to produce images. The schematic illustrations shown in FIGS. 10A and 10B are only two-dimensional, and the ureters that extend to the kidneys are not shown in these simple views, but it will be understood that the approach illustrated is applied to image the entire three-dimensional surface of the volume. In this simplified two-dimensional view, a plurality of points 378 are designated at spaced-apart intervals around the inner surface. Points 378 are set back from the surface an appropriate distance to enable the distal end of imaging probe 376 to produce an image of the surface at each point, adjacent images overlapping slightly to facilitate stitching them together to form an overall composite image of the inner surface. Initially, imaging probe 376 is inserted into the distended volume and positioned at the point selected to produce an image of portion 370 of the inner surface. In this initial position, the distal end of the imaging probe is not deflected. Next, an actuator is selectively activated to produce a mechanical force that deflects the distal end of the imaging probe in an imaging probe configuration 376′ shown in FIG. 10A. An image of a portion 372 is then produced with the imaging probe positioned to the left of the initial position. A succession of additional images are then produced by rotating the imaging probe to other points, such as the point appropriate to image a portion 374 of the surface.

Additional actuators can be activated to increase the deflection angle while both changing the insertion depth and rotating the imaging probe to produce images at each of the other points 378. This process can also be done by a user who is adequately trained manually controlling the proximal end, or can be automated by employing robotic control of the proximal end. FIG. 10B illustrates an imaging probe configuration 376″ to show the imaging probe after it has been deflected through a substantially greater arc compared to that shown in FIG. 10A. In FIG. 10B, the imaging probe is shown disposed at the points appropriate to image portions 380 and 382 of the surface. By rotating imaging probe configuration 376″, other points at that longitudinal position can also be imaged, as explained above.

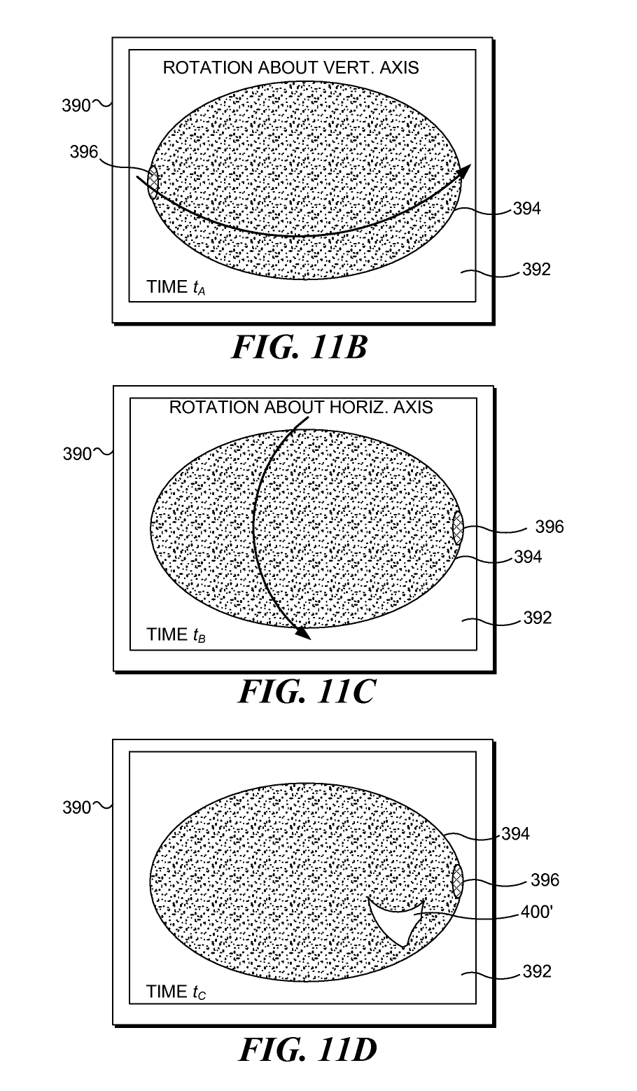

FIG. 11A illustrates a display 390 on which a composite overall image 392 of a surface 394 is displayed to show how a user can visually identify a portion of the surface that has NOT been imaged. An opening 396 is apparent in part of the image. In one discrete image 398, a portion 400 of the surface is omitted from the image, and that omission is visually evident to a user. The user would then likely use the imaging probe to ensure that portion 400 is also imaged, by appropriately positioning and orienting the imaging probe toward this portion of the surface. It is also possible that as each discrete image is produced, the user would visually note that portion 400 had been omitted from image 398 and take appropriate steps to reposition/orient the imaging probe to scan that omitted portion.

The composite overall image 392′ of a bladder surface is three-dimensional (3-D) and the entire surface may not be observable at any one time with sufficient image quality. Therefore, the 3-D surface image may be first projected or wallpapered onto a spherical or other shape, and this wallpapered spherical shape then rotated so the user can clearly see the fully scanned surface and thus, visually detect any portion of the surface that has not been scanned. For the spherical bladder (actually, more of an oblate spheroid shape), an analogy may be helpful for explaining the utility for this additional step to improve image understanding. The composite overall image can be projected onto the inside of a sphere of approximately the same size (radius) expected for the patient's size, sex, and bladder fill volume. However, to more efficiently view the composite image produced by the scan procedure to visually identify any omissions corresponding to portions of non-imaged bladder surface, the spherical wall thickness can be made very thin and transparent, so that the colored and more opaque surface image can be viewed from a viewer position disposed outside the sphere. FIGS. 11B, 11C, and 11D illustrate an example of this process. Rapid visualization of this composite image can be achieved by viewing the sphere at a time t_{A} as it rotates about one axis, e.g., the vertical as shown in FIG. 11B, and then at a time t_{B} as it rotates about another axis, e.g., the horizontal axis as shown in FIG. 11C. Finally, when the sphere is rotated 180° relative to the view shown in FIG. 11C, the omission of a portion 400′ of the internal surface will be evident, as shown in FIG. 11D. Because the actual bladder composite image will be somewhat distorted when projected onto a sphere, projecting the images onto a more anatomically-correct 3-D surface will significantly reduce image distortion due to mapping errors. However, if only portions of the surface omitted from the composite of the scanned images of the scanned surface of a volume are being visually identified, then image distortion is not critically important, and the composite image could be made simply monochrome or even represented as binary pixel information. By painting these simplified images onto an idealized 3-D surface having a high-contrast background, then omitted portions of the surface in the composite of the scanned surface of a volume can be clearly seen in real-time. A simplified visualization tool may be useful to help insure that the entire surface was imaged, then afterwards, the full-color, undistorted composite image may be analyzed for the purpose of screening or surveillance to detect a disease or quality feature (rust, cracks, holes—in non-medical applications), possibly in a location remote from the site of the imaging.

### Tracking Position/Orientation of Imaging Probe

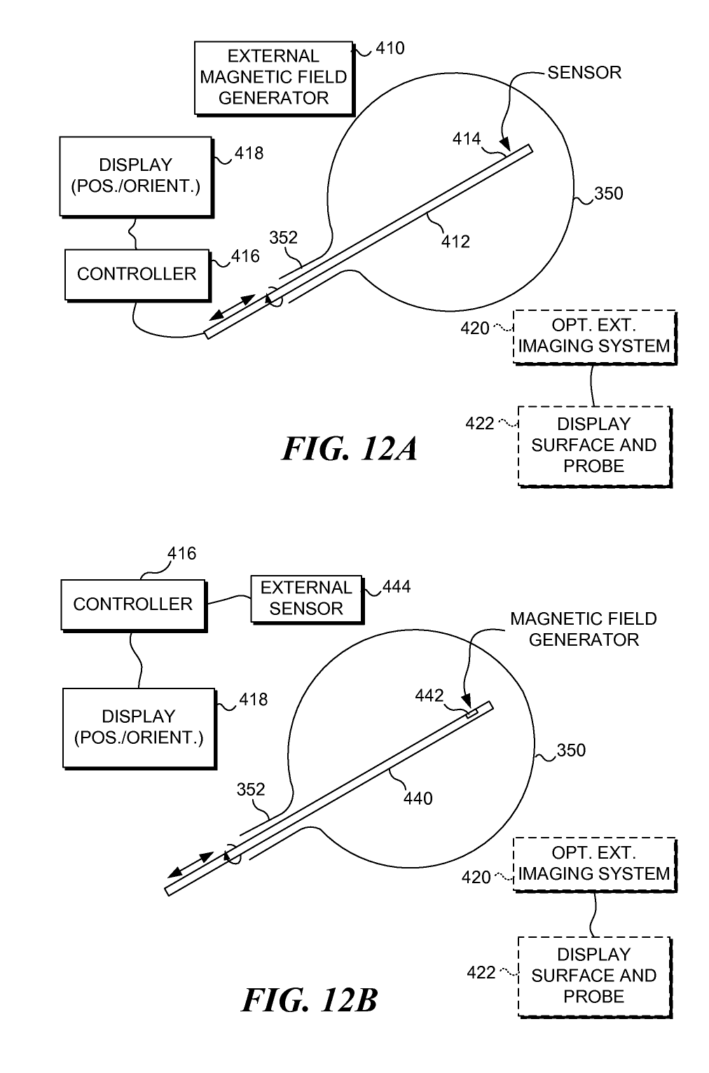

As indicated in FIG. 12A, one exemplary embodiment enables the actual position and orientation of a distal end 414 of an imaging probe 412 to be tracked or determined using an external electromagnetic field transmitter 410 that produces an electromagnetic field. Sensor 326 (as shown in FIGS. 8A and 8B) responds to the electromagnetic field by producing corresponding signals indicative of the position and orientation of the distal end of the imaging probe. These signals, which are conveyed through leads 328 (also shown in FIGS. 8A and 8B) are processed by an external controller 416 to provide an indication of the position and orientation of the imaging probe relative to the surface of the volume currently being imaged, on a display 418. Alternatively (or in addition), the position of the imaging probe within a volume, such as the bladder, may be monitored using ultrasound, fluoroscopy, or other well-known techniques. An optional external imaging system 420 produces such an image showing the volume and surface on an optional display 422.

In an alternative embodiment shown in FIG. 12B, an internal electromagnetic field transmitter 442 can be mounted adjacent to the distal end of an imaging probe 440, and one or more external sensors 444 can be employed to respond to the electromagnetic field produced by the internal electromagnetic transmitter, providing corresponding signals that are processed by controller 416 to again determine the position and orientation of the distal end of the imaging probe, which is shown on display 418. It is also contemplated that other forms of transmitters and sensors might instead be employed to monitor the position and orientation of the distal end of the flexible endoscope. For example, an external transmitter emitting modulated infrared (IR) light might be employed with a corresponding IR sensor that responds to the IR light received as the light passes through the surface of the volume being imaged.

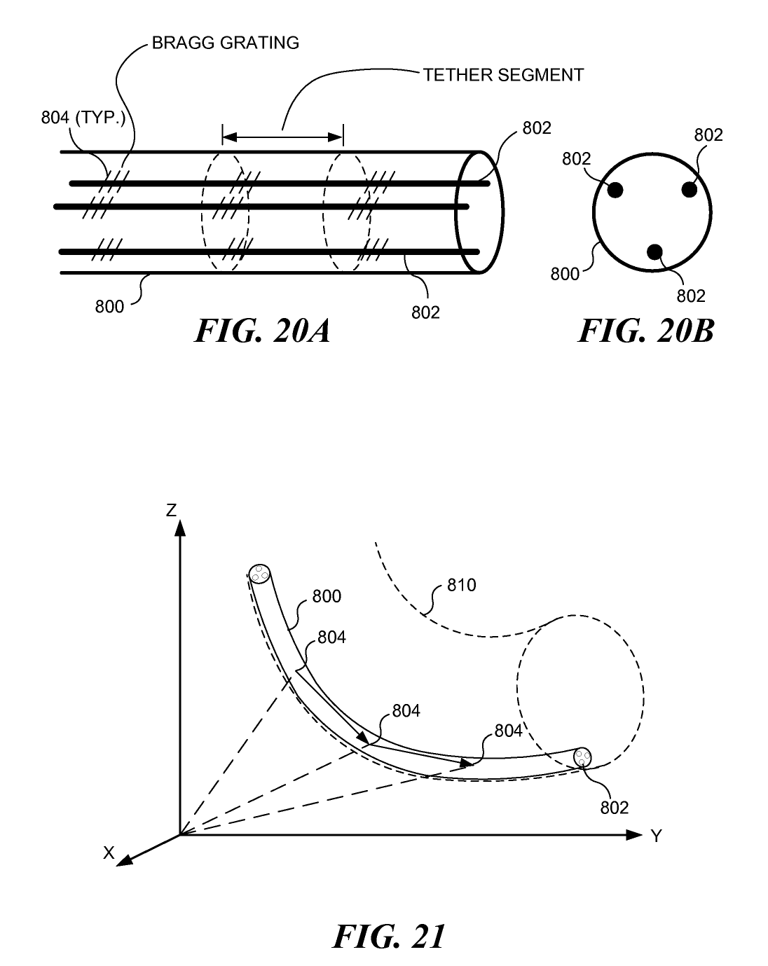

Yet another alternative approach is contemplated for sensing the position and orientation of the distal tip of an imaging probe within a volume, as illustrated in FIGS. 20A, 20B, and 21. As explained above, at least some exemplary embodiments of an imaging probe use multiple core optical fibers (e.g., such as reflection return optical fibers 302 in exemplary SFE 300, shown in FIG. 8A) for conveying light reflected from a surface distally to an optical sensor. These multiple core optical fibers can be fabricated to include a plurality of axially spaced-apart Bragg gratings, for use in detecting strain as the optical fiber is bent in an arc. The technique for measuring strain and thereby determining the shape and position of a distal end of the multiple core optical fiber is explained in a paper by Roger Duncan et al. entitled, “Characterization of a fiber-optic shape and position sensor,” Smart Structures and Materials 2006: Smart Sensor Monitoring Systems and Applications, Proc. of SPIE, Vol. 6167.

FIG. 20A illustrates a multiple core optical fiber 800 having three cores 802 arranged generally at the corners of an equilateral triangle and extending axially within the optical fiber. Fiber Bragg Gratings (FBGs) 804 are written into cores 802 of the multiple core optical fiber using a high-powered pulsed excimer laser (not shown) at a constant axial spacing. Each FBG 804 represents a periodic change in refractive index that reflects a very narrow band of light having an exact wavelength that is dependent on the period of the refractive index variation. When the multiple core optical fiber is subjected to a strain, the period of the refractive index variation is slightly affected, changing the wavelength of the light that is reflected by the FBG back to an interrogator (not shown) disposed at the proximal end of the optical fiber. At each axial position along cores 802, the FBGs on the three cores at that position together comprise a sensor triplet. The spacing between successive sensor triplets is identified in FIG. 20A as a “tether segment.” Since the signals produced in each of the three cores differs due to their geometry when the optical fiber is deflected, it is possible to use these distributed strain measurements at the spaced-apart sensor triplets along the multiple cores to determine the shape and change in position of the distal tip of the multiple core optical fiber relative to an initial reference position.

An Optical Frequency Domain Reflectrometry (ODFR) technique can be used to multiplex the FBG strain sensors. In the OFDR technique, a swept wavelength spectrally from a source (not shown) disposed at the proximal end of the multiple core optical fiber is used to interrogate multiple FBG strain sensors along the axis of the optical fiber. Details of this technique are further discussed in the above-referenced paper.

FIG. 21 illustrates how multiple core optical fiber 800 disposed in a flexible shaft 810 of an imaging probe can be employed to determine the deflection, and thus, the position and orientation of the adjacent distal tip (not shown in this Figure) of the imaging probe. The deflection of the multiple core and thus, of the shaft of the imaging probe can readily be determined in three dimensions, as illustrated in FIG. 21, to enable the position and orientation of the distal tip of the imaging probe to be tracked relative to an initial reference position.

### Automated Position Drive Station

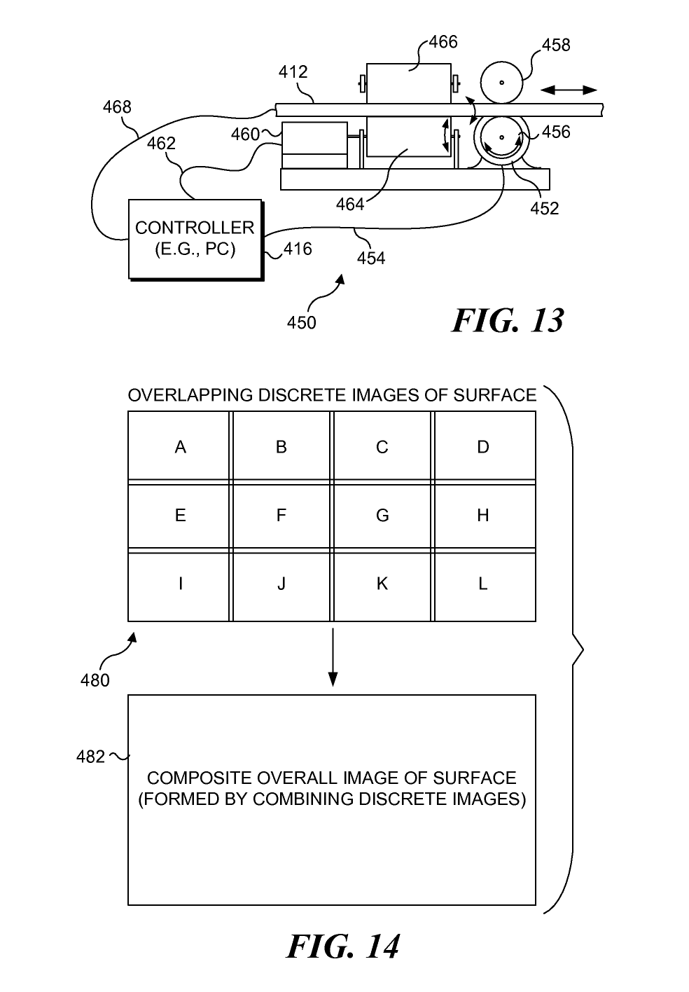

FIG. 13 illustrates an exemplary drive station 450 for use in automatically positioning the imaging probe within a volume, relative to different desired points that are spaced apart from the surface of the volume (as shown in the examples illustrated in FIGS. 10A and 10B). Drive station 450 responds to signals supplied by controller 416, which may be a personal computer (PC) or a hardwired dedicated device. The drive station includes a prime mover (e.g., a stepping motor) 452 that rotates an elastomeric drive wheel 456 in response to a signal supplied by controller 416 through a lead 454. Prime mover 452 can rotate in either direction to advance or retract a shaft 412 of the imaging probe, thereby controlling its insertion depth within the volume to image the inner surface of the volume. An idler wheel 458 applies pressure to ensure that elastomeric drive wheel applies a frictional force that can move the shaft in or out of the volume.

Another prime mover (e.g., another stepping motor) 460 is coupled to controller 416 through a lead 462 and responds to a signal from the controller to rotate shaft 412 of the imaging probe by rotating an elastomeric drive wheel 464, which frictionally/mechanically engages shaft 412 in cooperation with an idler wheel 466. Prime mover 460 can rotate elastomeric drive wheel 464 in either direction, to thereby rotate shaft 412 in either direction about its longitudinal axis. A lead 468 conveys the signals from controller 416 to the actuators disposed at the distal end of the imaging probe (not shown in this Figure), to selectively deflect the distal end of the imaging probe in a desired arc, generally as explained above, e.g., in connection with the example shown in FIGS. 10A and 10B.

Exemplary Imaging System Having Imaging Probe with Deflectable Tip

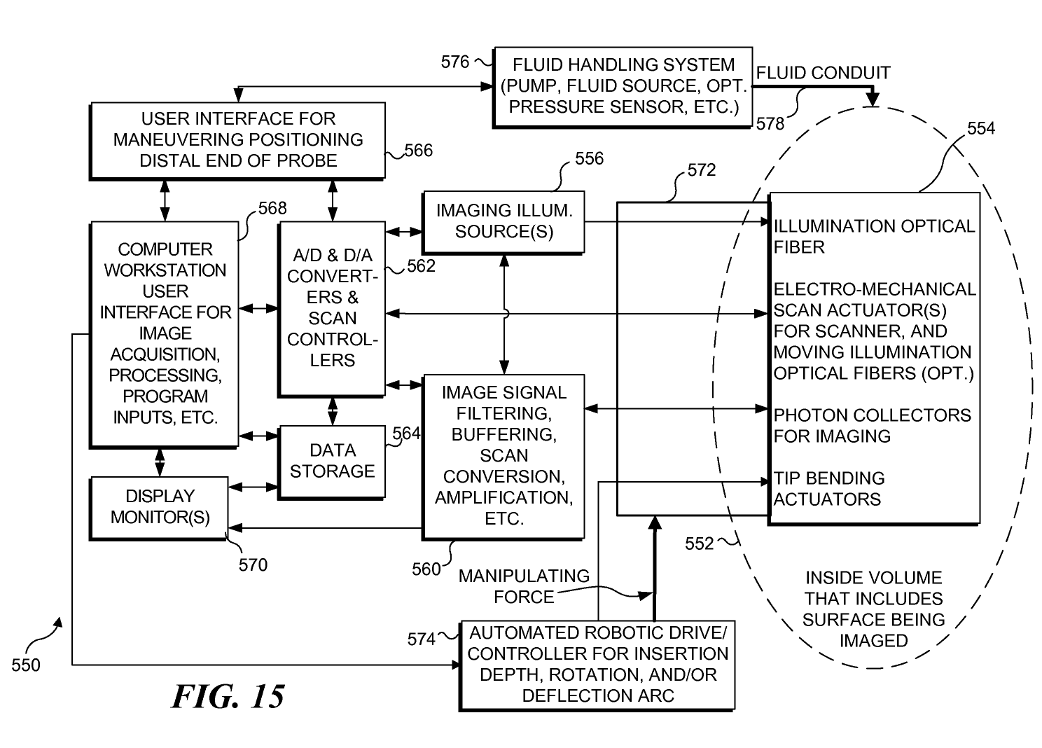

FIG. 15 illustrates a system 550 that shows how the signals produced by an SFE probe that is inside a patient's body are processed with external instrumentation, and how signals used for controlling the SFE probe system to vary the position and orientation of the SFE probe. In order to provide integrated imaging and other functionality, system 550 is thus divided into the components that remain external to the patient's body, and those which are used internally (i.e., the components on the imaging probe shown within a dash line 552). A block 554 lists the functional components disposed at the distal end of the imaging probe. As indicated therein, these exemplary components include illumination optics, one or more electromechanical scan actuator(s) that can drive the scanning optical fiber or scanning mirror, one or more illumination optical fiber actuator(s), received light optical fibers (or light detectors) for imaging the internal site. The photon collectors for imaging can be discrete sensors mounted on the SFE as discussed above in connection with FIG. 8B, or may be separate multimode optical fibers that convey light received from the surface, such as those shown in FIG. 8A. It should be noted that additional functions besides imaging can be implemented by the SFE, such as diagnostic or therapy functions, or any combination thereof.

Externally, the illumination optics and SFE are supplied light from imaging sources and modulators, as shown in a block 556. The signals produced in response to the light received from the surface while it is being imaged at each point are processed in a block 560. In block 560, image signal filtering, buffering, scan conversion, amplification, and other processing functions are implemented using the electronic signals produced by the imaging light detectors (internal or external) and any other light detectors employed for diagnosis/therapy purposes. Blocks 556, 560, and 562 are interconnected bi-directionally to convey signals that facilitate the functions performed by each respective block. Similarly, each of these blocks is bi-directionally coupled in communication with a block 562 in which analog-to-digital (A/D) and digital-to-analog (D/A) converters are provided for processing signals that are supplied to a computer workstation user interface or other computing or hardware device, which can be employed for image acquisition, processing, for executing related programs, and for other functions. Control signals from the computer workstation are fed back to block 562 and converted into analog signals, where appropriate, for controlling or effecting each of the functions provided in blocks 556, 560, and 562. The A/D converters and D/A converters within block 562 are also coupled bi-directionally to a block 564 in which data storage is provided, e.g., storage of the image data, and to a block 566. Block 566 represents a user interface for maneuvering, positioning, and orienting the imaging probe within the volume, relative to the surface.

In block 564, the data storage is used for storing the image data produced by the detectors within the volume, and for storing other data related to the imaging and functions implemented by the imaging probe. Block 564 is also coupled bi-directionally to a computer workstation 568 and to interactive display monitor(s) in a block 570. Block 570 receives an input from block 560, enabling images of the internal site to be displayed interactively. An automated robotic driver controller (and drive station) 574 is optionally provided to provide the manipulating force that enables the position and orientation of the imaging probe within the volume to be automatically controlled in response to a software algorithm to enable imaging of substantially the entire surface (or at least some desired portion of it) to be achieved. Also included is a fluid handling system 576, which includes the pump, fluid, source, optional sensor for monitoring fluid pressure within the volume, fluid conduit, and other components that are employed for pumping fluid under pressure into the volume, to distend the surface so that the surface can be more effectively imaged. The fluid handling system is electronically coupled to the user interface, to enable parameters such as fluid pressure to be entered by the user, and by a conduit 578 to the volume, to convey the fluid under pressure into the volume before and/or during the imaging procedure, as noted above.

Other Medical Applications of this Technology

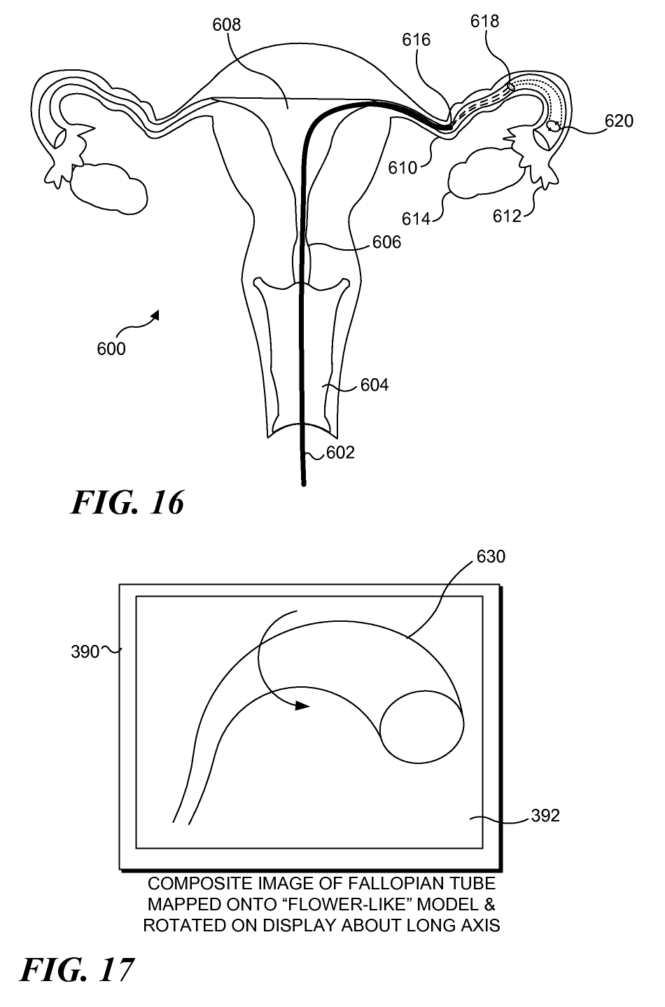

As noted above, the imaging probe having a distal end that can be remotely bent in a desired arc can be used in many other medical applications besides imaging the inner surface of a bladder and the upper urinary tract. For example, FIG. 16 schematically illustrates a female reproductive system 600 in which an imaging probe 602 has been inserted through a vagina 604, cervix 606, and uterus 608 and into a fallopian tube 610. A distal end 612 of the fallopian tube expands in cross-sectional area and has a much larger flower-like shape volume where it receives eggs from an ovary 614. Imaging probe 602 includes an SFE or other type of imaging device (not separately shown in this view) at its distal end that images the inner surface of the fallopian tube using different scanning modes, as a function of the insertion depth of the imaging probe into the fallopian tube. While moving up to a point 616, the imaging device produces forward view images, since the cross-sectional diameter of the fallopian tube is relatively small. As the imaging probe is inserted more deeply into the fallopian tube beyond point 616, the scan mode is changed to enable side-to-side viewing and imaging. When the insertion depth reaches a point 618, the scan mode changes to a spiral trajectory (as shown at a point 620) to produce images of the larger diameter portion of the fallopian tube while the distal end of the imaging probe is beyond point 618.

FIG. 17 illustrates display 390, showing an image 392 of a model 630 on which the composite image of the inner surface of the fallopian tube (produced with the exemplary procedure as described above in connection with FIG. 16). The composite image mapped onto model 630 is visible on the display as the model is slowly continuously rotated about its longitudinal axis, enabling a medical practitioner or other skilled user to readily identify characteristics of the surface, such as cancerous tissue.

### Exemplary Non-Medical Application of Novel Technology

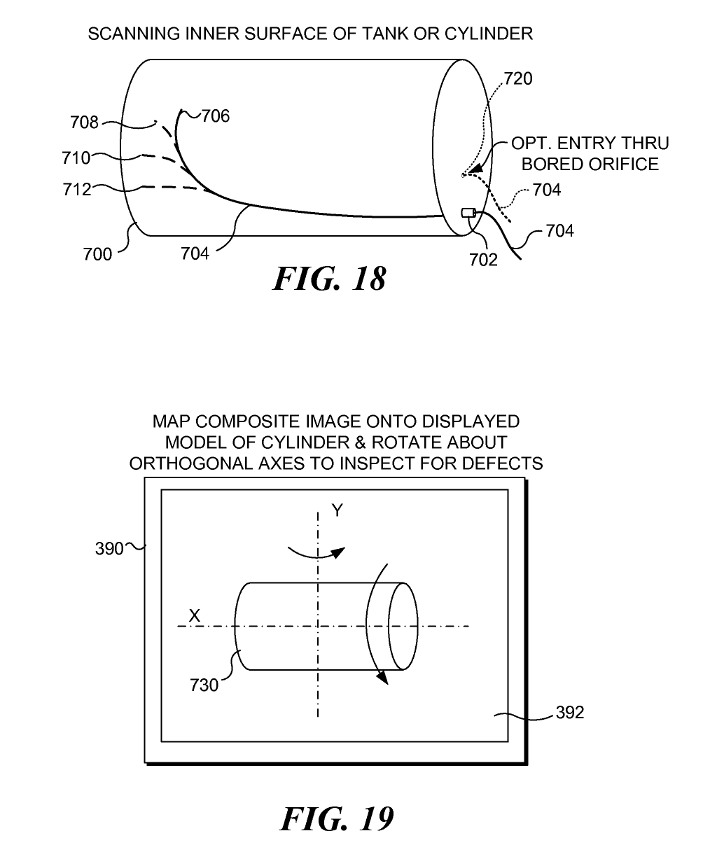

FIG. 18 illustrates one exemplary non-medical application of the present approach, in which the inner surface of a tank or cylinder 700 is imaged using a borescope 704 that is inserted through a small diameter opening (e.g., the opening for a drain plug) 702. Alternatively, if the cylinder does not have such an opening, an orifice 720 can be bored into one end of it and the borescope inserted into the interior of the cylinder through the orifice. The distal end of the borescope includes an imaging scanner (not separately shown) as generally described above. In addition, the distal end of borescope 702 can be remotely controlled to deflect in a desired arc, positioning the distal end at any of a number of different positions, such as positions 706, 708, 710, and 712 by way of example. Of course, the borescope insertion depth and rotation about its longitudinal axis can be manually or automatically robotically controlled, as described above, so as to ensure that substantially the entire inner surface of cylinder 700 is scanned to produce images.

An overall composite image of the inner surface can be produced by stitching together the discrete images, and the composite image can be mapped onto a cylindrical model 730. A user can observe the composite model in 3-D on display 390, as the model and composite image are rotated about either or both orthogonal axes X and Y, as illustrated in FIG. 19. By visually observing this composite image as it is rotated, the user can readily identify defects, such as rust, cracks, pits, holes, etc. in the inner surface.

Although the concepts disclosed herein have been described in connection with the preferred form of practicing them and modifications thereto, those of ordinary skill in the art will understand that many other modifications can be made thereto within the scope of the claims that follow. Accordingly, it is not intended that the scope of these concepts in any way be limited by the above description, but instead be determined entirely by reference to the claims that follow.

The invention in which an exclusive right is claimed is defined by the following:

1. A method for optically fully scanning a surface of a volume that is accessed through an opening, where a cross-sectional dimension of the volume is substantially greater than a cross-sectional dimension of the opening, comprising the steps of:
(a) inserting an elongate imaging probe through the opening and into the volume;
(b) applying a mechanical force, causing the elongate imaging probe to bend through a desired arc; and
(c) producing a plurality of overlapping images of the surface by positioning a distal end of the elongate imaging probe at a plurality of selected positions that are spaced apart from the surface of the volume, the step of positioning including one or more of the steps of:
(i) controlling an insertion depth of the elongate imaging probe into the volume;
(ii) rotating the elongate imaging probe about its longitudinal axis; and
(iii) modifying the mechanical force applied to selectively vary the desired arc through which the elongate scanning device is bent.

2. The method of claim 1, further comprising the step of processing discrete overlapping images produced by the elongate imaging probe so as to produce an overall image in which the overlapping discrete images are combined.

3. The method of claim 2, further comprising the step of enabling an operator to determine whether a desired portion of the surface has been fully optically scanned by displaying the overall image, wherein any region of the desired portion of the surface that has not been optically scanned is visually evident.

4. The method of claim 1, wherein the step of producing the plurality of overlapping images is automated in response to a control program that automatically controls at least one of the following, so as to ensure that substantially all of a desired portion of the surface is optically scanned:
(a) an insertion depth of the elongate optical scanner;
(b) a rotation of the elongate optical scanner about its longitudinal axis; and
(c) the mechanical force applied to bend the elongate optical scanner about an arc.

5. The method of claim 1, wherein the mechanical force is applied by at least one actuator disposed proximate to the distal end of the elongate optical scanner, wherein the step of applying the mechanical force comprises the step of activating the at least one actuator to produce a force that causes the elongate optical scanner to bend through the desired arc.

6. The method of claim 5, wherein the at least one actuator comprises a shape memory material selected from the group consisting of a shape memory alloy and a shape memory polymer, and wherein the step of activating comprises the step of supplying an electrical current to heat the at least one actuator, heating of the at least one actuator causing the at least one actuator to change shape, producing the force that bends the elongate optical scanner.

7. The method of claim 5, wherein the at least one actuator comprises an electro-active polymer, and wherein the step of activating comprises the step of applying an electrical potential across the at least one actuator, the electrical potential causing an ion migration within the electro-active polymer that changes the shape of the at least one actuator, producing the force that bends the elongate optical scanner.

8. The method of claim 1, further comprising the step of creating a model of the surface for use in determining the plurality of selected positions where the surface will be imaged.

9. The method of claim 1, further comprising the step of injecting a fluid under pressure into the volume to distend the surface, prior to optically scanning the surface.

10. The method of claim 1, further comprising the step of displaying each of the plurality of images as they are produced with the elongate optical scanner, to enable an operator to view the image to identify one or more specific characteristics of the surface.

11. A system for scanning a surface of a volume that is accessed through an opening, where a cross-sectional dimension of the volume is substantially greater than a cross-sectional dimension of the opening, the system comprising:
(a) an elongate imaging probe that is used for creating images of a surface that is being scanned, the cross-sectional dimension of the elongate imaging probe being sufficiently small to enable the elongate imaging probe to readily fit through the opening when inserted into the volume, and the elongate imaging probe being flexible at least adjacent to a distal end of the elongate imaging probe;
(b) at least one actuator disposed on the elongate imaging probe, for use in producing a mechanical force that bends the elongate imaging probe; and
(c) a plurality of electrical conductors coupled to the at least one actuator, the plurality of electrical conductors conveying an electrical signal used to selectively activate the at least one actuator, to bend the elongate imaging probe through a desired arc, the elongate imaging probe being thus bent in the desired arc and positionable within the volume while producing images of the surface at each of a plurality of positions that are selected to ensure that substantially all of at least a desired portion of the surface of the volume is scanned.

12. The system of claim 11, further comprising a flexible sheath that encloses the elongate imaging probe and includes an optically transparent window at its distal end to enable light to be transmitted while the elongate imaging probe is imaging the surface.

13. The system of claim 11, further comprising at least one light detector that receives light from the surface, the at least one light detector producing an output signal in response to the light received for use in producing images of the surface.

14. The system of claim 13, wherein the at least one light detector is disposed adjacent to the distal end of the elongate imaging probe and the output signal is conveyed by a plurality of leads that extend from the at least one light detector toward the proximal end of the elongate imaging probe.

15. The system of claim 13, further comprising at least one optical fiber that extends along the elongate imaging probe, from its distal end, toward a proximal end of the elongate imaging probe, the at least one optical fiber conveying the light received from the surface to the at least one light detector.

16. The system of claim 13, further comprising an image processor for processing the output signal, wherein the image processor processes a plurality of overlapping discrete images of different portions of the surface so as to produce an overall image in which the plurality of discrete images are combined.

17. The system of claim 16, further comprising a display on which the overall image is displayed to a user, to enable the user to determine if at least the desired portion of the surface has been fully scanned, by visually inspecting the overall image on the display to determine if any part of the desired portion of the surface is not visible in the overall image.

18. The system of claim 16, wherein the image processor controls imaging by the elongate imaging probe to produce the plurality of overlapping discrete images so as to ensure that substantially all of the desired portion of the surface is optically scanned, by automatically controlling at least one of the following:
(a) an insertion depth of the elongate imaging probe;
(b) a rotation of the elongate imaging probe about its longitudinal axis; and
(c) the bending of the elongate imaging probe about an arc.

19. The system of claim 16, further comprising a position sensing system that detects the position and orientation of the distal end of the elongate imaging probe within the volume, to enable the processor to control the position and orientation of the elongate optical sensor so as to ensure that substantially all of the desired portion of the surface has been imaged.

20. The system of claim 11, further comprising a source of a fluid that is injected into the volume through the opening under pressure to distend the surface, prior to optically scanning the surface with the elongate imaging probe.

21. The system of claim 11, wherein the at least one actuator comprises a shape memory material selected from the group consisting of a shape memory alloy and a shape memory polymer, and wherein the plurality of electrical conductors carry an electrical current to heat each actuator that is to be activated, heating of the actuator causing the actuator to change shape, producing the force that bends the elongate imaging probe.

22. The system of claim 11, wherein the at least one actuator comprises an electro-active polymer and wherein the plurality of electrical conductors supply an electrical potential that is applied across each actuator that is to be activated, the electrical potential causing an ion migration within the electro-active polymer that changes the shape of the actuator, producing a force that bends a distal portion of the elongate imaging probe.

23. A bendable imaging system, comprising:
(a) a flexible conduit within which is disposed an elongate imaging probe for use in producing images of a surface that is disposed adjacent to a distal end of the flexible conduit; and
(b) a plurality of actuators that are coupled to the elongate imaging probe, adjacent to a distal end of the flexible conduit, each of the plurality of actuators being selectively actuatable, causing the actuator to apply a force that bends the elongate imaging probe and the flexible conduit, one or more actuators being selectively activated so as to achieve bending of the elongate imaging probe and the flexible conduit through a desired arc, to control an orientation and position of the distal end of the elongate imaging probe relative to the surface that is being imaged.

24. The bendable imaging system of claim 23, wherein the plurality of actuators comprises a shape memory material selected from the group consisting of a shape memory alloy and a shape memory polymer, and wherein the shape memory material is selectively activated by supplying an electrical current through a plurality of conductors to heat each actuator that is selected, causing the shape memory material to change shape and produce a force that bends the flexible conduit and the elongate imaging probe through the desired arc.

25. The bendable imaging system of claim 23, wherein the plurality of actuators comprises an electro-active polymer that is selectively activated by supplying an electrical potential across each actuator that is selected, wherein the electrical potential is supplied through the plurality of conductors and causes an ion migration within the electro-active polymer that changes the shape of the selected actuator segment, producing a force that bends the flexible conduit and the elongate imaging probe through a desired arc.

26. A method for scanning substantially all of a surface within an internal volume that is accessed through an opening relatively smaller in a cross-sectional dimension than a cross-sectional dimension of the volume, to produce images of the surface in which a condition of the surface is visually evident, and so as to ensure that at least a desired portion of the surface has been imaged, comprising the steps of:
(a) inserting an imaging probe into the volume through the opening;
(b) successively remotely positioning the imaging probe at each of a plurality of positions selected to enable imaging of different parts of the surface;
(c) remotely bending a distal end of the imaging probe to assist in the step of remotely positioning by applying a mechanical force to the imaging probe proximate to the distal end, thereby bending the imaging probe to change a position and an orientation of the imaging probe relative to a portion of the surface that is currently being imaged;
(d) at each of the positions, using the imaging probe for imaging the surface to produce a plurality of images of the surface; and
(e) providing an indication to a user of the imaging device that indicates whether images have been produced for substantially all of at least the desired portion of the surface.

27. The method of claim 26, wherein the step of successively remotely positioning includes the step of successively remotely changing a depth of insertion of the imaging probe into the volume.

28. The method of claim 26, wherein the step of successively remotely positioning includes the step of successively remotely rotating the imaging probe about a longitudinal axis of the imaging probe.

29. The method of claim 26, further comprising the step of injecting a fluid under pressure into the volume to distend the surface before imaging the surface.

30. The method of claim 26, further comprising the step of displaying the images that are produced to the user to enable the user to visually determine whether substantially all of at least the desired portion of the surface has been imaged by the imaging probe.

31. The method of claim 26, further comprising the step of combining the images of the surface to create an overall composite image in which any part of the surface that has not been imaged is visually evident, the step of providing an indication to the user, comprising the step of displaying the overall composite image to the user to enable the user to visually determine if substantially all of at least the desired portion of the surface has been imaged.

32. The method of claim 26, further comprising the step of determining whether images of the surface of at least a predefined quality are being produced.

33. The method of claim 26, further comprising the step of positioning and orienting the imaging probe to image any part of at least the desired portion of the surface that has been identified by the user as having not yet been imaged.

34. The method of claim 26, wherein the step of remotely positioning is carried out automatically using a controller that controls a position of the imaging probe within the volume while the imaging probe is being used for imaging.

35. The method of claim 34, wherein the step of remotely bending comprises the step of using the controller to activate one or more actuators that are disposed on the imaging probe, adjacent to its distal end.

36. The method of claim 35, wherein the controller selects one or more specific actuators to be activated, so as to bend the distal end of the imaging probe through an arc that will position and orient the distal end at successive positions chosen to ensure that at least the desired portion of the surface is imaged.

37. The method of claim 26, wherein the step of remotely bending comprises the step of enabling a user to selectively activate one or more actuators that are disposed on the imaging probe, adjacent to its distal end, so as to bend the distal end of the imaging probe through an arc that will position and orient the distal end at successive positions chosen to ensure that at least the desired portion of the surface is imaged.

38. The method of claim 26, wherein the step of remotely positioning the imaging probe comprises the step of enabling a user to manually manipulate a proximal portion of the imaging probe to enable imaging of the surface at each of the plurality of positions.

39. The method of claim 26, wherein the surface visually exhibits at least one characteristic condition, further comprising the step of displaying the plurality of images of the surface so as to enable the user to determine whether the at least one characteristic condition is visible in any of the plurality of images.

40. The method of claim 26, further comprising the step of sensing a position of the imaging probe in the volume, producing a signal indicative of at least one of the position and orientation of the imaging probe, wherein the step of providing the indication to the user comprises the step of providing the indication produced in response to the signal to the user, to enable the user to modify at least one of the position and orientation of the imaging probe so as to ensure that substantially all of at least the desired portion of the surface is imaged.

41. The method of claim 26, wherein a plurality of actuators are disposed on the imaging probe, adjacent to the distal end of the imaging probe, wherein the step of remotely bending comprises the step of applying an electrical signal for activating one or more selected actuators, activation of the one or more selected actuators causing the one or more selected actuators to change shape, producing a force that bends the imaging probe through an arc.
